(19) United States
(12) Patent Application Publication
(10) Pub. No.: US 2010/0198120 A1
(43) Pub. Date: Aug. 5, 2010

(54) CHAIR-TYPE MASSAGE MACHINE

(75) Inventors: Mitsunori Tago, Tottori (JP); Tomoharu Fukuda, Tottori (JP); Yoshifumi Fukuyama, Tottori (JP); Shiro Watanabe, Tottori (JP); Koji Goto, Osaka (JP)

Correspondence Address: DRINKER BIDDLE & REATH (DC), 1500 K STREET, N.W., SUITE 1100, WASHINGTON, DC, 20005-1209, US

(73) Assignee: Family Co. LTd, Osaka (JP)

(21) Appl. No.: 12/669,098

(22) PCT Filed: Jul. 22, 2008
(86) PCT No.: PCT/JP2008/001948

§ 371 Date: Jan. 14, 2010

(30) Foreign Application Priority Data
Jul. 24, 2007 (JP) 2007 192356
Oct. 15, 2007 (JP) 2007 268012
Jul. 16, 2008 (JP) 2008 185345

(51) Int. Cl. A61H 1/02; A61H 15/00

(52) U.S. Cl. 601/134; 601/105

(57) ABSTRACT

A control section (50) of a chair-type massage machine (1) is configured so that air cells (7c) press the area around the lumbar of the user supported on a backrest section (3) to push up the area in conjunction with the backward tilting of the backrest section (3) performed using an actuator (37).

### TECHNICAL FIELD

The present invention relates to a chair-type massage machine having a backrest section capable of being tilted backward while holding the upper body of the user sitting on a seat section from behind and treatment sections provided for the backrest section, more particularly, to a chair-type massage machine capable of stretching the user. Furthermore, the present invention relates to a chair-type massage machine including a seat section on which the user sits, a backrest section for supporting the upper body of the user sitting on the seat section from behind, and thigh treatment sections provided so as to be opposed to the outside faces of the thighs of the user sitting on the seat section, in particular, to a chair-type massage machine capable of pressure-treating sites other than the thighs while holding the thighs of the user sitting on the seat section.

### BACKGROUND ART

Conventionally, numerous chair-type massage machines are known that are provided with a seat section on which the user sits and a backrest section for supporting the upper body of the user sitting on the seat section from behind. In this kind of chair-type massage machine, plural air cells are provided in the seat section, the backrest section, etc., and a mechanical treatment mechanism is provided in the backrest section; these air cells and treatment mechanism are used to perform pressure massage, such as rubbing and pounding, for the user. Furthermore, a machine is proposed in which a rocking mechanism provided in the seat section thereof is driven after the backrest section thereof is tilted backward so as to flex the lumbar (for example, refer to Patent document 1).

Moreover, among such chair-type massage machines, a machine capable of treating the thighs of the user sitting on the seat section thereof is proposed (for example, refer to Patent document 2). In the case of the chair-type massage machine described in Patent document 2, air cells are disposed on the inside faces of the left and right armrests thereof provided so as to stand on the sides of the seat section, and these air cells are expanded by supplying air from a pump, thereby being capable of pressure-treating the thighs of the user sitting on the seat section.

Patent document 1: JP-2007-167434-A

Patent document 2: JP-2006-255155-A

### DISCLOSURE OF THE INVENTION

### Problem to be Solved by the Invention

As treatments to be performed for the user, rubbing, pounding, etc. are available as described above; however, in addition to these, stretching is desired to be performed. In particular, stretching is very comfortable for the user after a series of massage operations is done, for example, there are many cases in which the user having been pressure-massaged by the use of a chair-type massage machine stands up from the seat section and then stretches themself. However, in the conventional chair-type massage machines, such as that disclosed in Patent document 1 described above, even if the backrest section is tilted backward to its limit, for example, the user cannot obtain a sufficient stretching feeling.

Furthermore, with respect to the treatment for the thighs, since the thighs are smaller in weight than the torso among the body parts of the user and have a wider movable range, when an attempt is made to pressure-treat the thighs of the user sitting on the seat section, the thighs are moved by the pressure force of the treatment, and it becomes difficult to perform proper treatment in some cases. For example, when the user sits on the seat section, if the ankles make contact with the ground or if the thighs are supported from below using the footrest, the contact pressure between the thighs and the seat section becomes small or the thighs are spaced away from the seat section in an extreme case; hence, the posture of the thighs becomes changeable due to the pressure force from the outside, and it becomes difficult to perform proper pressure treatment. In particular, when the thighs are pressure-treated from the outside as disclosed in Patent document 2, the thighs are moved easily to the inside.

On the other hand, by the expansion of an air cell disposed between the left and right thighs to support the thighs from the inside, the thighs can be made difficult to move by the pressure force from the outside. However, in this case, an air cell that expands vastly is required to be disposed at the central portion of the seat section; in addition, generally speaking, the upper portion of this air cell is required to be covered with a cover that is folded into a bellows shape and can be spread out when the air cell is expanded. In the configuration in which the air cell is disposed at the center of the seat section and covered with the folded cover, problems will occur, for example, dirt, such as dust, will be likely to easily accumulate between the gaps in the folded cover.

Furthermore, if an air cell, a cover being folded and thick, etc. are disposed in the seat section (in particular, on the insides of the thighs), they may give the user an uncomfortable feeling.

Accordingly, the present invention is intended to provide a chair-type massage machine from which the user can obtain a sufficient stretching feeling and also intended to provide a chair-type massage machine capable of pressure-treating the thighs while the thighs of the user sitting on the seat section are held properly.

### Means for Solving the Problem

(1) The present invention is contrived in consideration of the above-mentioned circumference, and a chair-type massage machine according to the present invention includes a seat section on which the user sits, a backrest section that supports the upper body of the user sitting on the seat section from behind, an actuator that raises/lowers the backrest section, a pressing section that is disposed inside the backrest section and that presses the upper body of the user from behind, and a control section that controls operations of the actuator and the treatment section, wherein the control section is configured so that the pressing section presses and pushed up around the lumbar of the user supported on the backrest section in conjunction with a backward tilting of the backrest section performed using the actuator.

With this configuration, the pressing section pushes up the area around the lumbar of the user in conjunction with the backward tilting of the backrest section; hence, the entire body of the user can be stretched in the body length direction. In particular, since the area around the lumbar is pushed up, the upper body of the user has a posture of being bent backward, whereby it is possible to obtain a stretching feeling more favorable than that obtained conventionally.

(2) In addition, the control section may be configured so that the pressing section presses and pushes up around the lumbar of the user after the backward tilting of the backrest section using the actuator is completed. With this configuration, the area around the lumbar is pushed up while the user is set completely in a state of lying on the back, whereby the effect of stretching the user can be improved.

(3) Furthermore, the machine may further include: a footrest that is provided forwardly of the seat section and that supports the legs of the user sitting on the seat section, wherein the footrest is provided with holding sections that hold a given site falling within a range from the ankles to the toes of the legs of the user, and wherein the control section is configured so that the holding sections hold the given sites of the user when the pressing section presses around the lumbar. With this configuration, the legs can be held more securely, whereby the displacement of the body of the user can be restricted securely and further improvement in the effect of stretching can be attained.

(4) Moreover, the footrest may be configured so that a lower portion thereof is moveable up/down by rocking with respect to an upper portion thereof as an axis, and wherein the control section may be configured so that the footrest is moved down in conjunction with the backward tilting of the backrest section so as to obtain a state where the legs of the user are bent at the knees. With this configuration, when the backrest section is tilted backward, the legs are supported in a state of being bent at the knees using the footrest; hence, when the backrest section is tilted backward and when the area around the lumbar is pushed up using the pressing section, the body is hardly displaced upward, whereby further improvement in the effect of stretching can be attained. More specifically, the displacement of the lower body in conjunction with the backward tilting of the backrest section is restricted since the legs are supported at the footrest, whereby the body of the user is stretched in the body length direction; additionally, the displacement of the lower body in conjunction with the pushing up of the area around the lumbar using the pressing section is also restricted, whereby the body of the user is further stretched.

(5) Besides, the pressing section may have: a left side pressing section disposed relatively on a left side; and a right side pressing section disposed relatively on a right side, and wherein the control section may be configured so that either the left side pressing section or the right side pressing section pushes up around the lumbar of the user from either left or right in conjunction with the backward tilting of the backrest section. With this configuration, for example, the body of the user can be twisted clockwise by the pressing using the left side pressing section, and the body can be twisted counterclockwise by the pressing using the right side pressing section, whereby stretching can be attained while twisting is performed.

(6) What's more, the machine may further include: a holding section that holds the upper body of the user supported on the backrest section, wherein the control section is configured so that the holding unit holds the upper body of the user in conjunction with the backward tilting of the backrest section. With this configuration, since the upper body is held, the displacement of the upper body to the lower legs is restricted when the backrest section is tilted backward, whereby stretching is performed so that the entire body is extended further.

(7) Also, the machine may further include: a seat rocking section that is provided in the seat section and that rocks the buttocks of the user sitting thereon, wherein the control section is configured so that the seat rocking section starts rocking the buttocks before the pressing section presses around the lumbar. With this configuration, the user is set in a relaxed state physically and mentally by virtue of the rocking of the buttocks and then stretched, whereby the effect of stretching can be improved.

(8) Additionally, the machine may further include: a treatment section that performs a pressure massage for the user, wherein the control section is configured so that the pressing section presses and pushes up around the lumbar after the pressure massage for the user using the treatment section is performed. With this configuration, it is possible to attain a series of massage operations in which stretching is performed after pressure massage and the user can have a refreshed feeling.

(9) Still further, a chair-type massage machine according to the present invention includes: a seat section on which the user sits; a backrest section that supports the upper body of the user sitting on the seat section from behind; and thigh treatment sections that are provided so as to be opposed to the outside faces of the thighs of the user sitting on the seat section, wherein the thigh treatment sections include: thigh holders that hold the thighs of the user; front side treatment devices that are disposed forwardly of the thigh holders and that pressure-treat the thighs; and rear side treatment devices that are disposed backwardly of the thigh holders and that pressure-treat the thighs.

With this configuration, while the thighs are held using the thigh holders, the thighs can be pressure-treated appropriately using the front side treatment devices and the rear side treatment devices. Furthermore, it is not necessary to provide air cells in the seat section to hold the thighs, thereby being advantageous in that dirt hardly accumulates on the seat section.

(10) In addition, the thigh holder may have: a first air cell that is expanded and contracted when air is supplied/exhausted and that is formed to be a flat shape in a contracted state, wherein the first air cell may be provided to protrude upward from a seat face of the seat section making contact with the user, and wherein the first air cell is configured so that an upper portion thereof is expanded when air is supplied thereto while a lower portion thereof is used as a base end. With this configuration, the upper portion of the first air cell that is expanded while the lower portion thereof is used as a base end presses each thigh from above, whereby the first air cell can hold the thigh properly.

(11) Furthermore, at least one of the front side treatment device and the rear side treatment device may have: a second air cell that is expanded and contracted when air is supplied/exhausted and that is formed to be a flat shape in a contracted state, wherein the second air cell is provided to protrude upward from the seat face, and wherein the second air cell is configured so that, while an end portion of a side being close to the thigh holder is used as a base end, an end portion of a side being far away from the thigh holder is expanded when air is supplied. With this configuration, the second air cell of the front side treatment device can pressure-treat each thigh at around the knee from the outside, and the second air cell of the rear side treatment device can pressure-treat the thigh at around the lumbar from the outside. As a result, while these sites are pressed, a pressure point referred to as knee yokan (also referred to as “leg yokan”) at around the knee and a pressure point referred to as kyoryo or kancho at around the lumbar can be pressed and stimulated.

(12) Moreover, the first air cell of the thigh holder may be configured so that an upward protrusion dimension from the seat section is larger than that of the second air cell of the front side treatment device or the rear side treatment device. With this configuration, the first air cell of the thigh holder can press each thigh from a higher level, whereby the thigh holder can hold the thigh more securely.

(13) Besides, the machine may further include: a control section that controls operations of the thigh holders, the front side treatment devices and the rear side treatment devices, wherein the control section is configured so as to be able to control the thigh holders, the front side treatment devices and the rear side treatment devices independently of one another. With this configuration, various treatments can be performed for the thighs of the user.

(14) What's more, the control section may be configured to operate at least one of the front side treatment device and the rear side treatment device to pressure-treat each thigh while the thighs of the user sitting on the seat section are held using the thigh holder. With this configuration, while the posture of the thighs is held nearly constant, the thighs can be pressure-treated from the outside.

(15) Also, the seat section may be provided with seat section treatment devices that upwardly pressure-treat the lower faces of the thighs or buttocks of the user sitting thereon upward, and wherein the control section may be configured to operate the seat section treatment devices while the thighs of the user are held using the thigh holders. With this configuration, even when the thighs are pressure-treated upward using the seat section treatment devices, the thighs are held using the thigh holders; hence, upward dislocation of the thighs due to an upward pressure force can be prevented, and the treatment using the seat section treatment device can be made effective.

(16) Still further, the backrest section may be provided with back section treatment devices that forwardly pressure-treat the lumbar or the back of the user whose upper body is held thereon, and wherein the control section may be configured to operate the back section treatment devices while the thighs of the user are held using the thigh holders. With this configuration, the seating position of the user can be prevented from being displaced forward when the lumbar or the back is pressure-treated; as a result, the lumbar or the back can be pressure-treated properly.

### EFFECTS OF THE INVENTION

The present invention can provide a chair-type massage machine from which the user can obtain a sufficient stretching feeling and can also provide a chair-type massage machine capable of pressure-treating the thighs while the thighs of the user sitting on the seat section are held properly.

### BRIEF DESCRIPTION OF THE DRAWINGS

FIG. 1 is a perspective view showing an overall configuration of a chair-type massage machine according to Embodiment 1 of the present invention.

FIG. 2 is a front view showing the chair-type massage machine shown in FIG. 1.

FIG. 3 is a plan view showing the chair-type massage machine shown in FIG. 1.

FIG. 4 is a perspective view showing the configuration of a head support section of the chair-type massage machine.

FIG. 5 is a block diagram showing the configuration of the chair-type massage machine.

FIG. 6 is a perspective view showing the configuration of a seat rocking mechanism for rocking a seat section in the left-right direction.

FIGS. 7A and 7B are side views showing the states of the rising/lowering movements of a backrest section and the up/down movements and the expansion/contraction movements of a footrest, FIG. 7A showing a state where the backrest section is raised and the footrest being contracted is moved down, FIG. 7B showing a state where the backrest section is tilted backward and the footrest being extended is moved up.

FIG. 8 is an external view showing the configuration of a remote controller that is used when the user themself operates operation units of the chair-type massage machine.

FIG. 9 is a table exemplifying a list of control items that can be performed for the respective operation units of the chair-type massage machine using a control section.

FIG. 10 is a schematic view showing changes in the posture of the user when stretching is performed for the user who is sitting on the seat section and whose upper body is supported on the backrest section to stretch the back muscles.

FIG. 11 is a schematic view showing changes in the posture of the user when another type of stretching is performed to stretch the back muscles of the user.

FIGS. 12A to 12C are schematic views showing changes in the posture of the user when still another type of stretching is performed to stretch the back muscles of the user.

FIG. 13 is a table showing specific operation control performed by the control section in a quick course, the horizontal axis thereof representing steps to be executed in consecutive time order.

FIG. 14 is another table showing specific operation control performed by the control section in the quick course, the horizontal axis thereof representing steps to be executed in consecutive time order.

FIG. 15 is a side view showing another configuration of the chair-type massage machine capable of stretching the back muscles of the user.

FIG. 16 is a side view showing still another configuration of the chair-type massage machine capable of stretching the back muscles of the user.

FIG. 17 is a perspective view showing an overall configuration of a chair-type massage machine according to Embodiment 2 of the present invention.

FIG. 18 is a plan view showing the configuration of the chair-type massage machine, shown in FIG. 17, for mainly treating the thighs of the user using thigh treatment sections and the like.

FIG. 19 is a side view showing the chair-type massage machine shown in FIG. 18.

FIG. 20 is an enlarged view showing the thigh treatment sections shown in FIG. 18.

FIGS. 21A and 21B are schematic views for illustrating the operations of air cells provided in the respective sections, FIG. 21A being a front view of the chair-type massage machine, FIG. 21B being a side view thereof.

FIG. 22 is a block diagram illustrating the mechanical functions of the chair-type massage machine.

FIGS. 23A to 23D are timing charts illustrating the treatment operations performed for the user by the chair-type massage machine, FIGS. 23A to 23D respectively showing variations in operation.

FIGS. 24A to 24D are timing charts illustrating the treatment operations performed for the user by the chair-type massage machine, FIGS. 24A to 24D respectively showing other variations in operation.

FIGS. 25A and 25B are timing charts illustrating the treatment operations performed for the user by the chair-type massage machine, FIGS. 25A and 25B respectively showing still other variations in operation.

### EXPLANATIONS OF LETTERS OR NUMERALS

1 chair-type massage machine
2 seat section
3 backrest section
4 armrest
5 footrest
6 head support section
6a pillow section
7 air cell
7a to 7s air cells
8 vibrator
8a seat vibrator
8b back vibrator
9 treatment mechanism
10 seating face body
11 seat cushion
14 upper footrest
15 lower footrest
16 pillow section
20 elbow rest section
25 finger pressure protrusion
27 massaging balls
28 air cell
31 seat rocking mechanism
37 actuator
39 actuator
40 expanding/contracting mechanism
50 control section
51 air supplying/exhausting apparatus
60 remote controller
101 chair-type massage machine
102 seat section
102d seating face section
103 backrest section
104 armrest
105 footrest
107 massaging mechanism
120 thigh treatment section
121 thigh holder
124, 125 sitting treatment devices (seat section treatment devices)
126, 127 lumbar treatment devices (back treatment devices)
130a to 130c air cells
141 holding air cell (first air cell)
141a, 142a, 143a base end portions
141b, 142b, 143b expansion portions
142, 143 treatment air cells (second air cells)
144 to 147 treatment air cells
200 control section

### BEST MODES FOR CARRYING OUT THE INVENTION

### Embodiment 1

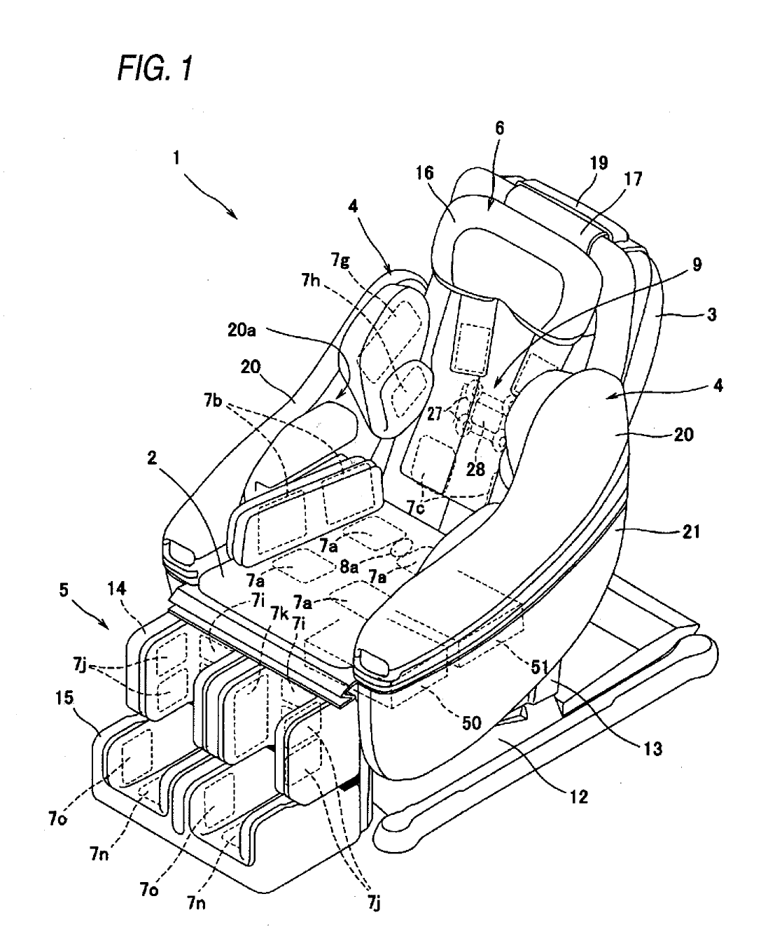

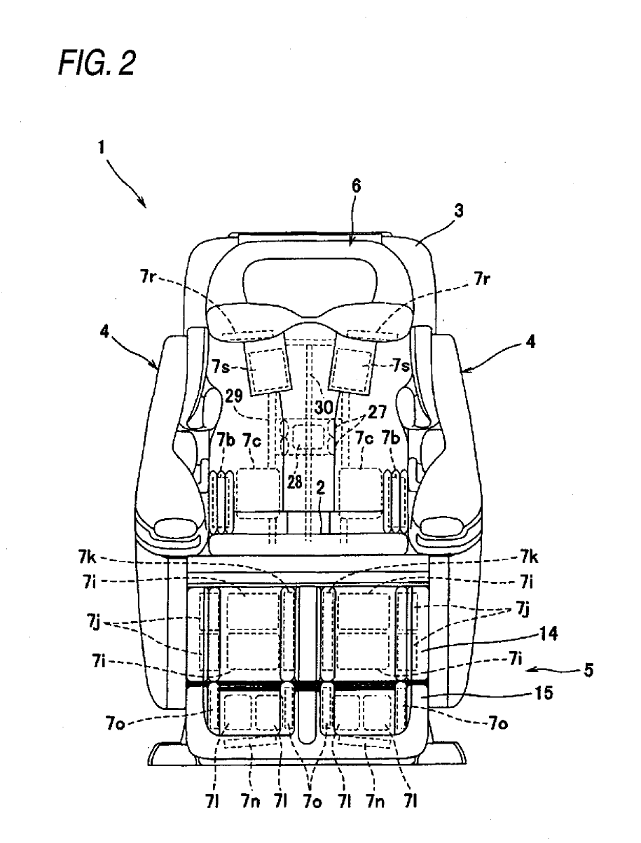

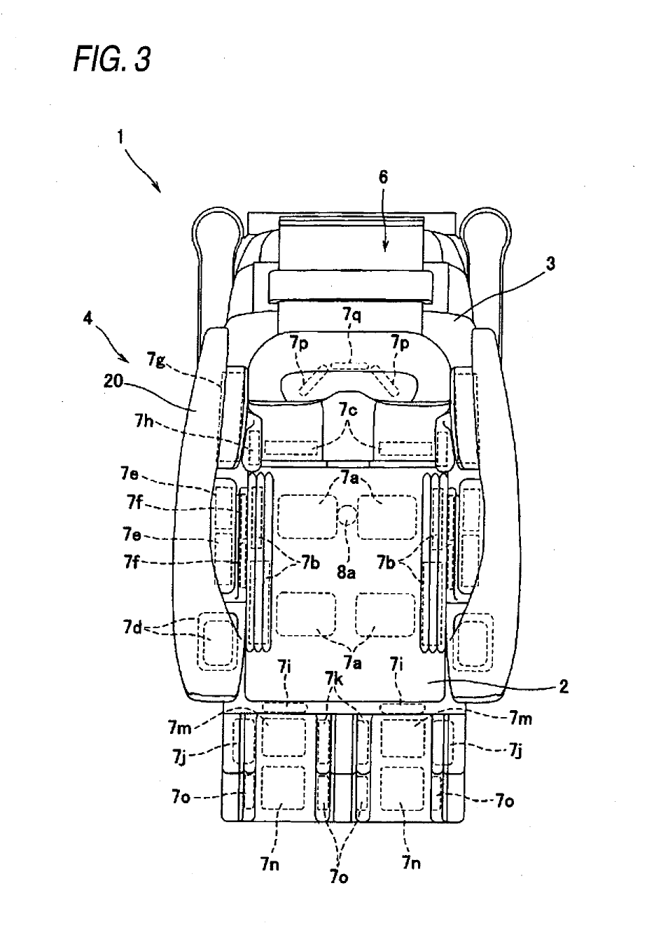

A chair-type massage machine according to Embodiment 1 of the present invention will be described below specifically referring to the drawings. FIG. 1 is a perspective view showing an overall configuration of the chair-type massage machine according to Embodiment 1 of the present invention. In addition, FIG. 2 is a front view showing this chair-type massage machine, and FIG. 3 is a plan view showing this chair-type massage machine. As shown in FIG. 1, the chair-type massage machine 1 mainly includes a seat section 2 on which the user sits, a backrest section 3 for supporting the upper body of the user from behind, armrests 4 for supporting the arms of the user, and a footrest 5 for supporting the legs of the user. It is assumed that the concept of the directions used in the following description coincides with the concept of the directions as viewed from the user sitting on the seat section 2 and that other cases will be explained as necessary.

[Overall Configuration]

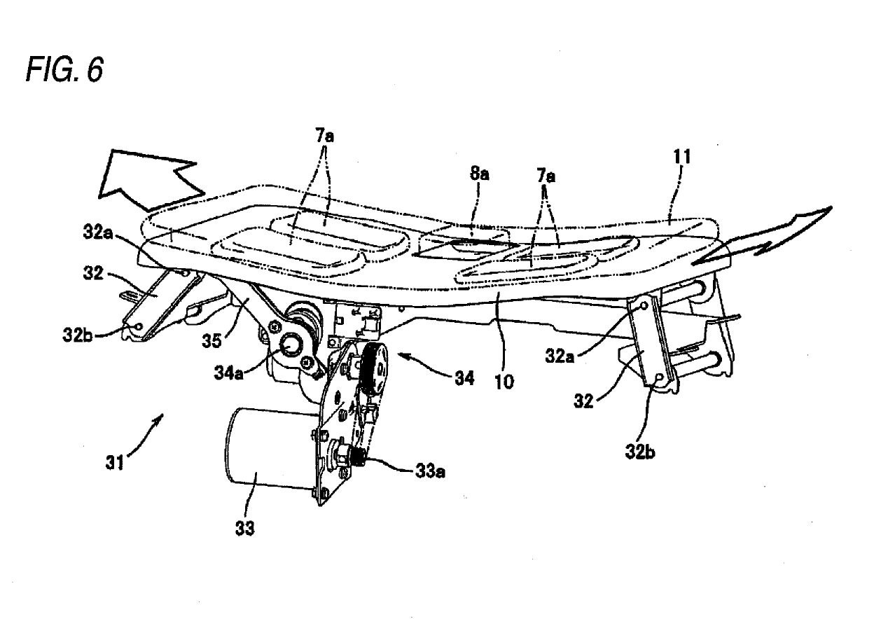

As shown in FIGS. 1 to 3, the seat section 2 is formed into a rectangular shape in planar view, a flat seat cushion 11 (see FIG. 6) is disposed above a rectangular-shaped seating face body 10 (see FIG. 6), and these are supported using a seat frame 13 provided above a base 12. This seat cushion 11 is configured so that an interior material, such as urethane foam, sponge or styrene foam, is covered with an exterior cover formed of raised tricot made of polyester, synthetic leather or natural leather.

The footrest 5 for treating the portions ranging from the knees to the toes of the legs of the user are disposed on the front side of the seat section 2. This footrest 5 is formed into a nearly L-shape in side view and includes an upper footrest 14 corresponding to the portions ranging from the knees to the ankles (hereafter referred to as “lower leg”), mainly the calves, and a lower footrest 15 corresponding to the portions ranging from the ankles to the toes (hereafter referred to as “foot”), these being respectively provided for the right and left legs.

The upper footrest 14 is grooved in shape so as to be open forward and can support the calves from behind and from the left and right sides using the inner bottom faces opposed to the back faces of the calves and the inner side faces opposed to the left and right side faces of the calves. Furthermore, the lower footrest 15 is grooved in shape so as to open upward and can support the foots from below and from the left and right sides using the inner bottom faces opposed to the soles of the feet and the inner side faces opposed to the left and right side faces of the foots.

The backrest section 3 for supporting the back face of the upper body of the user from behind is provided on the rear side of the seat section 2. In order to support the upper body of the user, the backrest section 3 is designed to have a size to the extent that when an average-built adult sits on the chair-type massage machine 1, no part of the body of the adult protrudes from the outside thereof, and is formed into a vertically-elongated nearly rectangular shape in front view. Furthermore, above this backrest section 3, a head support section 6 for supporting the head of the user whose upper body is supported on the backrest section 3 is disposed.

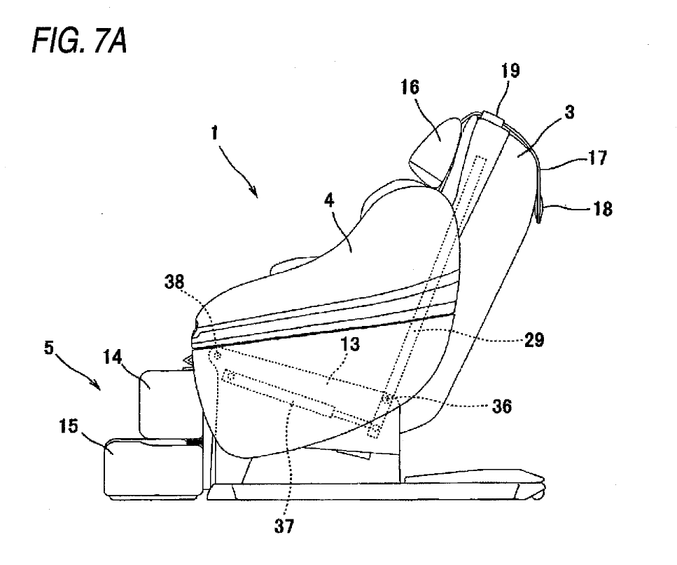

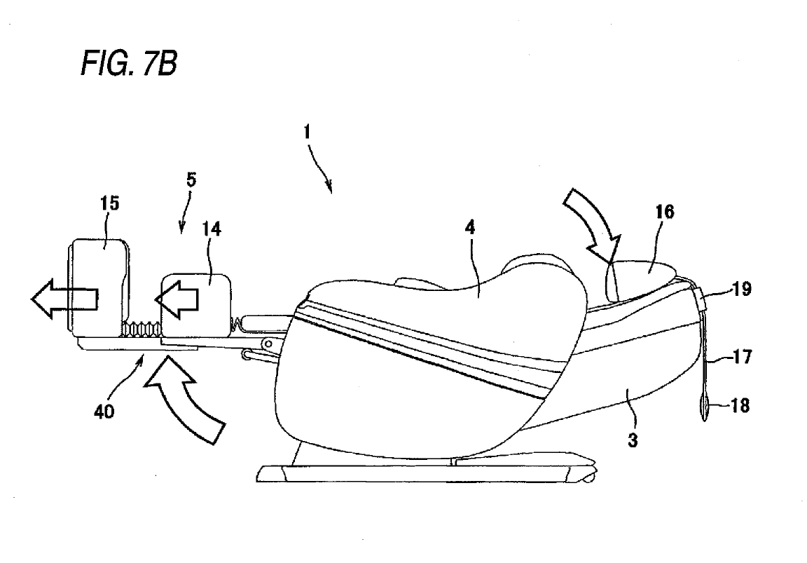

This head support section 6 includes a pillow section 16 for supporting the head of the user from behind, a belt-shaped position adjustment belt 17 extending from above the pillow section 16, and a weight 18 (see FIGS. 7A and 7B) installed at the tip end of the belt 17 and having a weight as heavy as that of the pillow section 16. On the other hand, a belt passing band 19 extending long in the left-right direction is provided at the upper end of the backrest section 3, and both ends thereof are secured to the backrest section 3. Furthermore, in the head support section 6, while the pillow section 16 is positioned on the upper front side of the backrest section 3, the belt 17 is passed through between the belt passing band 19 and the upper end of the backrest section 3. Hence, the pillow section 16 and the weight 18 hang down in the front-rear direction while the upper end of the backrest section 3 serves as the boundary therebetween and they are maintained in a balanced state, whereby the position of the pillow section 16 can be adjusted in the up-down direction.

In addition, on the left and right sides of the seat section 2 and the backrest section 3, the armrests 4 for supporting the arms of the user sitting on the seat section 2 are disposed so as to be extended forward in a direction from the side positions of the backrest section 3 to the seat section 2. This armrest 4 includes an elbow rest section 20 at the upper portion thereof and a side cover 21 at the lower portion thereof. The elbow rest section 20 has a nearly cylindrical shape and is extended from a position slightly above the vertically central portion of the backrest section 3 being in a raised state and corresponding to the side of a shoulder of the user whose upper body is supported using the backrest section 3 to the vicinity of the front end of the seat section 2, downward and forward. Furthermore, an opening 20a allowing an arm of the user to be inserted/extracted into/from the elbow rest section 20 is formed in the inside portion of the elbow rest section 20 ranging from the rear end of the elbow rest section 20 to the vicinity of the central position thereof in the front and back direction. Hence, the arm of the user inserted into the inside of the elbow rest section 20 through this opening 20a can be supported so that the finger tips thereof can be supported around nearly entire circumference and so that the portions ranging from the vicinity of the wrist to the upper arm and shoulder via the elbow can be supported from below, from outside and from above, respectively.

With the thus-configured chair-type massage machine 1, the user sitting on the seat section 2 is supported so that the entire body is enclosed by the back face and the left and right faces thereof. Furthermore, various operation units for treating the user are of the chair-type massage machine 1. In other words, plural air cells 7 and vibrators 8 are provided at appropriate positions of the chair-type massage machine 1 and are expanded and contracted so as to be able to press the user. In addition, a treatment mechanism 9 is provided mechanically in the backrest section 3 so as to be able to press the back of the upper body of the user. Furthermore, the seat section 2 can be rocked left and right, the backrest section 3 can be raised and lowered, and the footrest 5 can be moved up and down and expanded/contracted. These operation units of the chair-type massage machine 1 will be described below.

[Air Cells]

As shown in FIGS. 1 to 3, four air cells 7a arranged in the front-rear direction and the left-right direction are provided in the seat section 2, and these air cells 7a are made of plastic and have a configuration in which two flat cells having one internal space are stacked in the up-down direction. Furthermore, the left and right air cells 7a provided on the rear side are expanded/contracted by air supplying/exhausting of an air supplying/exhausting apparatus 51 (see FIG. 1), thereby applying pressure so as to push up the left and right side portions of the buttocks of the user sitting on the seat section 2 from below. Similarly, the left and right air cells 7a provided on the front side are expanded/contracted by air supplying/exhausting of the air supplying/exhausting apparatus 51, thereby applying pressure so as to push up the left and right side portions of the thighs of the user sitting on the seat section 2 from below. Moreover, the seating face body 10 according to this embodiment is depressed in a concave shape so that the central portion thereof is positioned so as to be lower than the left and right ends thereof (see FIG. 6), and the air cells 7a are disposed on the inclined face ranging from the left and right ends to the central portion on the upper face of the seating face body 10. Hence, when the air cells 7a are expanded, the buttocks of the user are pressed upward so as to be slightly sandwiched in the left-right direction.

Air cells 7b and 7b arranged in parallel in the front-rear direction are provided at the upper portions on both side portions of the seat section 2. The air cells 7b on the rear side are formed of three plastic cells stacked, and the air cells 7b on the front side are formed of three plastic cells stacked and one cloth cell further stacked on the surface thereof, whereby all the air cells are expanded to the central side in the left-right direction by supplying air thereto. The air cells 7b configured as described above are expanded/contracted, thereby being capable of pressing an areas continuously ranging from the side portions of the buttocks (or the lumbar) of the user sitting on the seat section 2 to the front side portions of the thighs in the direction from the outside to the inside, whereby the buttocks (or the lumbar) can be held so as to be sandwiched in the left-right direction by simultaneously expanding the left and right air cells 7b.

Two air cells 7c arranged in the left-right direction with a predetermined space therebetween are provided in the lower portion of the backrest section 3. These air cells 7c are formed of three cloth cells stacked, and press, from behind, the left and right side portions of the lumbar of the user whose upper body is supported on the backrest section 3 when expanded/contracted.

As shown in FIG. 3, plural air cells 7d to 7h are provided on the inner wall face of the cylindrical elbow rest section 20 provided for each of the armrests 4 so as to correspond to the hand, lower arm, upper arm and shoulder. Among these, the air cells 7d provided corresponding to the hand are formed of three cloth cells stacked and are provided on the upper face and the lower face of the inner wall face corresponding to the back and palm of the hand at the front portion of the elbow rest section 20, thereby being capable of pressing the hand of the user while sandwiching the hand in the up-down direction.

In addition, the air cells 7e and 7f are provided on the outside and the inside so as to correspond to the lower arm. Among these, the air cells 7e provided on the outside are formed of two plastic cells stacked, and the two air cells are disposed in the front-rear direction along the longitudinal direction of the lower arm. Furthermore, the air cell 7e on the front side can press the outside portion and the upper portion of the lower arm front portion, and the air cell 7e on the rear side can press the outside portion and the upper portion of the lower arm rear portion. The other air cells 7f provided on the inside are formed of one plastic cell and, the two air cells are disposed in the front-rear direction along the longitudinal direction of the lower arm as in the case of the air cells 7e. Furthermore, the air cell 7f on the front side can press the lower portion and the inside portion of the lower arm front portion, and the air cell 7f on the rear side can press the rear portion and the inside portion of the lower arm rear portion. Moreover, the air cells 7e and 7f are expanded simultaneously, thereby being capable of enclosing and pressing the entire lower arm toward the center of the lower arm.

In addition, the air cells 7g and 7h are provided so as to correspond to the upper arm and the shoulder. Among these, the air cell 7g provided on the outside is formed of two plastic cells stacked and has a long dimension extending from the shoulder to the vicinity of the elbow. The other air cell 7h provided on the inside is formed of one plastic cell and disposed so as to be opposed to the front side portion of the air cell 7g. The air cell 7g on the outside can press the outside portions of the upper arm and the shoulder, and the air cell 7h on the inside can press the inside portion of the upper arm. Furthermore, the air cells 7g and 7h are expanded simultaneously, thereby being capable of pressing the shoulder from the outside while pressing (and holding) the upper arm so as to sandwich the upper arm from the inside and outside.

As shown in FIGS. 1 to 3, the footrest 5 is provided with plural air cell 7i to 7o. More specifically, in the upper footrest 14, two air cells 7i formed of one plastic cell are provided in the up-down direction at positions opposed to the back face of each calf, two air cells 7j formed of two plastic cells are provided in the up-down direction at positions opposed to the outside face of the calf, and one air cell 7k formed of one plastic cell and having a long dimension in the up-down direction is provided at a position opposed to the inside face of the calf. These air cells 7i to 7k can press the calf of the user from behind and from both sides.

In addition, in the lower footrest 15, air cells 71 are provided at positions opposed to the left and right of each ankle, an air cell 7m is provided at a position opposed to the rear portion of the sole (the lower portion of the ankle), an air cell 7n is provided at a position opposed to the front portion of the sole, and air cells 7o are provided at positions opposed to the left and right side portions of the toes; the air cells 7i to 7o are all formed of one plastic cell. Among these, the air cells 7l can press (and hold) the ankle (in particular, the area around the Achilles' tendon) while sandwiching the ankle from the left and right sides when expanded, the air cells 7m and 7n can press the rear portion and the front portion of the sole while pushing them upward when expanded, and the air cells 7o can press (and hold) the instep of the foot while pushing it down from above when expanded.

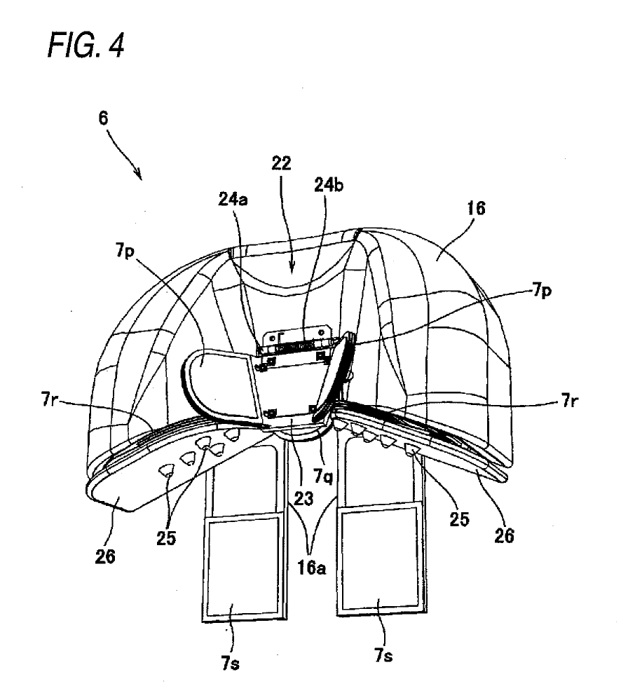

Also in the head support section 6, plural air cells 7p to 7s are provided. FIG. 4 is a perspective view showing the configuration of the head support section 6. As shown in FIG. 4, the front face of the pillow section 16 of the head support section 6 is depressed backward at the central portion thereof in the left-right direction in the range from the lower end to the upper end of the pillow section 6a, whereby a groove-shaped concave portion 22 extending in the up-down direction is formed. This concave portion 22 supports portions ranging from the neck to the rear head portion of the user from behind and from both sides. Furthermore, below this concave portion 22, the two air cells 7p are provided along the left and right side faces of the concave portion 22. These air cells 7p are formed of three cloth cells stacked and can press the portions ranging from the neck to the rear head portion from the left and right so as to sandwich the portions.

In addition, the rear portions of the left and right air cells 7p are unitized by being connected via a connection plate 23, and the upper end portion of this connection plate 23 is supported using a pivot 24, the axial center of which is oriented in the left-right direction, on the rear face of the concave portion 22 of the pillow section 16. Hence, the lower portions of the left and right air cells 7p can be rocked in the front-rear direction together with the connection plate 23 while the pivot 24a is used as a base point. Furthermore, a coil spring 24b is fitted around the pivot 24a, this coil spring 24b biases the connection plate 23 backward, and the air cell 7q formed of three cloth cells stacked is provided behind the connection plate 23. Hence, when the air cell 7q is expanded, the left and right air cells 7p are rocked forward together with the connection plate 23; when contracted, the air cells are rocked backward by the biasing force of the coil spring 24b. When the air cell 7q is expanded while the air cells 7p are expanded, pressure treatment can be performed so that the neck and the rear head portion of the user are rubbed from the lower portion to the upper portion while being sandwiched between the air cells 7p.

The air cells 7r are provided on the left and right sides of the lower face of the pillow section 16. These air cells 7r are formed of four cloth cells stacked and expanded downward by supplying air, thereby being capable of pressing the shoulders of the user whose upper body is supported on the backrest section 3 from above. In addition, plural finger pressure protrusions 25 are protrudingly provided on the lowest faces of the air cells 7r, and these finger pressure protrusions 25 protrude downward from the lower face of the cushions 26 while passing through the through-holes provided in sheet-shaped cushions 26 attached onto the lowest faces of the air cells 7r. Hence, when the air cells 7r are expanded, the finger pressure protrusions 25 can apply finger pressure to the shoulders of the user from above.

Furthermore, drooping bands 16a formed into a vertically-elongated rectangular shape are hung from the left and right sides of the back face of the pillow section 16. The air cells 7s formed of one plastic cell are installed at the lower portions of the drooping bands 16a, and the air cells 7s can press the rear portions of the shoulders (around the blade bones) of the user from behind when expanded.

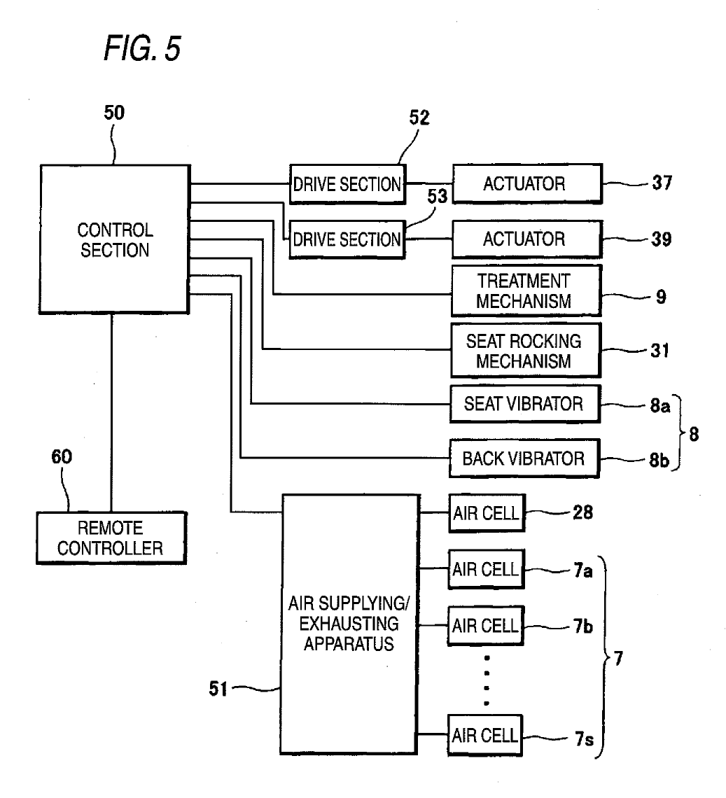

FIG. 5 is a block diagram showing the configuration of the chair-type massage machine 1. As shown in FIG. 5, the air cells 7a to 7s are connected to the air supplying/exhausting apparatus 51 formed of a pump, valves, etc. via flexible hollow air tubes. The air supplying/exhausting apparatus 51 is accommodated below the seat section 2 and driven according to instructions from a control section 50 that is also accommodated below the seat section 2, thereby being capable of supplying/exhausting air to/from the air cells 7a to 7s independently of one another. Furthermore, the air supplying/exhausting apparatus 51 is driven according to instructions from the control section 50, and the air cells 7a to 7s are expanded/contracted, thereby being capable of performing pressure treatment for the entire body of the user and also being capable of holding the arms, the buttocks (or the lumbar), the lower legs and the feet.

[Treatment Mechanism]

As shown in FIG. 2, a rectangular-frame-shaped back frame 29 is accommodated inside the backrest section 3, and a treatment mechanism 9 is provided mechanically so as to be supported on this back frame 29. This treatment mechanism 9 has four massaging balls 27 disposed in the up-down direction and the left-right direction (see also FIG. 1), and the two left massaging balls 27 and the two right massaging balls 27 are respectively installed at the upper and lower ends of arms (not shown) being opened forward such that a V-shaped member is inclined 90 degrees. To this arm, a motor (not shown) is connected via a mechanical reduction mechanism formed of pulleys, belts and various kinds of gears; when this motor is driven, the massaging balls 27 are moved three-dimensionally, thereby being capable of performing various kinds of pressure treatments, such as rubbing, pounding and finger-pressure treatment, for the back of the upper body of the user.

In addition, the treatment mechanism 9 formed of the massaging balls 27, the arm, the reduction mechanism, the motor, etc. as described above is screw-threaded with a ball screw 30 provided inside the backrest section 3 so that the axial center thereof is oriented in the up-down direction; when the ball screw 30 is driven and rotated by a motor (not shown), the treatment mechanism 9 can be moved up and down in the up-down direction inside the backrest section 3. Hence, rolling massage can be performed on the back of the upper body of the user in the range from the lumbar to the shoulders by moving the treatment mechanism 9 up and down.

Moreover, an air cell 28 that is expanded/contracted by supplying/exhausting air is provided behind the treatment mechanism 9, and the treatment mechanism 9 can be moved in front-rear direction by expanding/contracting this air cell 28. Hence, the lumbar and the back of the user whose upper body is supported on the backrest section 3 can be pressed so as to be pushed out. The upper portion of the treatment mechanism 9 according to this embodiment is supported on the back frame using a pivot whose axial center is oriented in the left-right direction, and the lower portion thereof can be moved so as to be rocked in the front-rear direction while the upper portion is used as a base point when the air cell 28 is expanded/contracted.

[Vibrators]

As shown in FIG. 5, the chair-type massage machine 1 according to this embodiment includes a seat vibrator 8a (also see FIG. 1) for treating the buttocks of the user and a back vibrator 8b for treating the lumbar and the back as the vibrators 8. As shown in FIG. 1, the seat vibrator 8a is disposed between the left and right air cells 7a in the rear portion of the seat section 2 (also see FIG. 6) and has a known configuration in which an eccentric mass is mounted on the output shaft of a motor. When the seat vibrator 8a is driven according to an instruction from the control section 50, vibratory stimulation can be applied to the buttocks of the user sitting on the seat section 2.

On the other hand, the back vibrator 8b is installed on the arms of the above-mentioned treatment mechanism 9 and has a configuration similar to that of the seat vibrator 8a. When the back vibrator 8b is driven according to an instruction from the control section 50, its vibration is transmitted to the massaging balls 27 via the arms, whereby vibratory stimulation can be applied to the lumbar and the back of the user with which the massaging balls 27 make contact.

[Seat Rocking Mechanism]

FIG. 6 is a perspective view showing the configuration of a seat rocking mechanism 31 for rocking the seat section 2 in the left-right direction. As shown in FIG. 6, the seat rocking mechanism 31 is provided below the seating face body 10, and in the left and right lower portions of the seating face body 10, the upper end portions of first link rods 32 are pivoted using first shafts 32a whose axial centers are oriented in the front-rear direction. The left and right first link rods 32 are disposed in a downwardly-opening posture in front view, and the lower end portions thereof are pivoted on the seat frame 13 (see FIG. 1) using second shafts 32b whose axial centers are oriented in the front-rear direction.

In addition, the seat rocking mechanism 31 includes a motor 33 and a reduction mechanism 34, and these are supported using the seat frame 13. The reduction mechanism 34 is configured so that the rotation of the output shaft 33a of the motor 33 is input, the rotation speed thereof is lowered and the direction of the rotation center thereof is changed into the front-rear direction, and the reduced rotation is output from an output shaft 34a. The tip end portion of this output shaft 34a is formed into a crank shape, and one end of a second link rod 35 is pivoted at the tip end portion, and the other end of the second link rod 35 is pivoted using either one of the left and right first shafts 32a.

Accordingly, when the motor 33 is driven and rotated, the rotation is input to the reduction mechanism 34, and the tip end portion of the output shaft 34a of the reduction mechanism 34 performs an orbiting movement having a predetermined radius. Then, following this movement, one end of the second link rod 35 also performs an orbiting movement, thereby reciprocating the first shaft 32a pivoting the other end in the left-right direction. As a result, the seating face body 10 on which the first shafts 32a are installed is rocked in the left-right direction as indicated by arrows shown in FIG. 6, thereby being capable of reciprocating the buttocks of the user sitting on the seat section 2 in the left-right direction. The movement of the seat rocking mechanism 31 described above is performed based on instructions from the control section 50 as shown in FIG. 5.

[Tilting Mechanisms of Backrest Section and Footrest]

FIGS. 7A and 7B are side views showing the states of the rising/lowering movements of the backrest section 3 and the up/down movements and the extension/contraction movements of the footrest 5, FIG. 7A showing a state where the backrest section 3 is raised and the footrest 5 being contracted is lowered, FIG. 7B showing a state where the backrest section 3 is tilted backward and the footrest 5 being extended is moved up.

As shown in FIG. 7A, the back frame 29 inside the backrest section 3 is supported at a position slightly above the lower end portion thereof using the rear portion of the seat frame 13 via pivots 36 disposed in the left-right direction. In addition, one end of a direct-acting actuator 37 formed of an air cylinder or the like is pivoted at the lower end portion of the back frame 29, and the other end of the actuator 37 is pivoted at the front portion of seat frame 13. Hence, when the actuator 37 is extended and contracted, the upper portion of the backrest section 3 is turned around the pivots 36 in the front-rear direction together with the back frame 29, whereby the backrest section can be raised (see FIG. 7A) and tilted backward (see FIG. 7B).

The actuator 37 is connected to the control section 50 via a drive section 52 (see FIG. 5) and is extended/contracted when an electrical signal is input from the drive section 52 according to an instruction from the control section 50. Furthermore, when the backrest section 3 is fully tilted backward, the angle formed by the upper face of the seat section 2 and the upper face of the backrest section 3 (the front face when being raised) is approximately 170 degrees, whereby the user supported on the seat section 2 and the backrest section 3 is in a state of nearly lying on the back.

On the other hand, the upper end portion of the footrest 5 provided forwardly of the seat section 2 is supported at the front portion of the seat frame 13 using pivots 38 whose axial centers are oriented in the left-right direction. Furthermore, by the extending/contracting operation of a direct-acting actuator 39 (see FIG. 5) formed of an air cylinder or the like, the lower portion can be moved up and down so as to be turned in the front-rear direction (in the up-down direction) around the pivots 38. In other words, by the contraction of the actuator 39, the footrest 5 is moved down, and a state (see FIG. 7A) in which the lower footrest 15 is positioned below the upper footrest 14 is obtained; by the extension of the actuator 39, the footrest 5 is moved up, and a state (see FIG. 7B) in which the lower footrest 15 is positioned forwardly of the upper footrest 14 is obtained.

Like the actuator 37, the actuator 39 is also connected to the control section 50 via a drive section 53 (see FIG. 5) and is extended/contracted when an electrical signal is input from the drive section 53 according to an instruction from the control section 50. In addition, when the actuator 39 is extended and the footrest 5 is fully moved up, the portion of the upper footrest 14 for supporting the back faces of the calves and the portion of the lower footrest 15 for supporting the heels are positioned so as to be approximately the same height. Furthermore, when the actuator 39 is contracted and the footrest 5 is fully moved down, the legs of the user sitting on the seat section 2 are bent at approximately 90 degrees at the knees so that a state where the lower legs ranging from the knees to the ankles are supported using the footrest 5 while being oriented in a nearly vertical direction is obtained.

Furthermore, the footrest 5 includes an extending/contracting mechanism 40. Although not described in detail since mere a known configuration is adoptable for the extending/contracting mechanism 40, the extending/contracting mechanism 40 can move the upper footrest 14 and the lower footrest 15 so that they are close to or separated from the pivots 38. In the footrest 5 according to this embodiment, when a relative distance between the pivots 38 and the lower footrest 15 is changed, by half the displacement amount thereof, a relative distance between the pivots 38 and the upper footrest 14 is changed. Moreover, although this extending/contracting operation of the footrest 5 may be performed automatically according to instructions from the control section 50, the footrest 5 according to this embodiment is designed so as to be extended/contracted depending on the force applied by the soles of the user to press the lower footrest 15.

In other words, when the lower footrest 15 is pressed by a predetermined force or more, the lower footrest 15 is moved in a direction of being separated from the pivots 38; in conjunction with this movement, the upper footrest 14 is also moved in a direction of being separated from the pivots 38. Conversely, when the force applied by the soles to press the lower footrest 15 is less than the predetermined force, both the lower footrest 15 and the upper footrest 14 are moved in a direction of becoming close to the pivots 38 by virtue of the action of a biasing unit provided separately. In this way, the upper footrest 14 and the lower footrest 15 are designed so as not to be forcibly extended/contracted by the control section 50; however, whether a stopper (not shown) provided separately to restrict the extension/contraction described above is valid/invalid can be determined by the control section 50, and the above-mentioned extension/contraction of the footrest 5 can be performed only when the control section 50 makes the stopper invalid.

[Remote Controller]

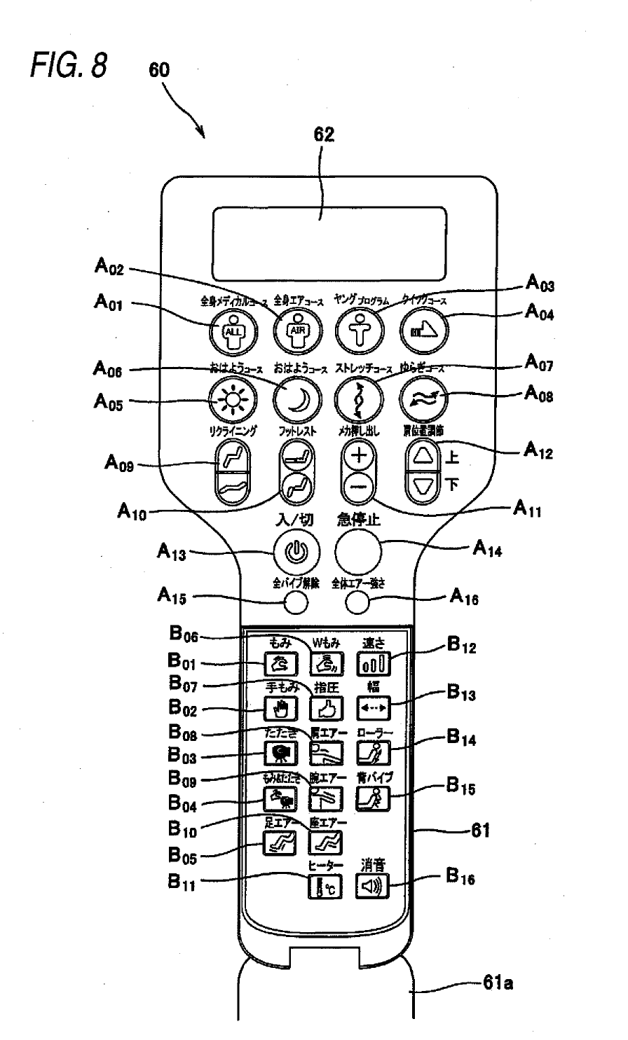

FIG. 8 is an external view showing the configuration of a remote controller 60 that is used when the user themself operates the above-mentioned operation units of the chair-type massage machine 1. As shown in FIG. 8, the lower portion of the remote controller 60 is made narrower than the upper portion thereof, and the narrow lower portion serves as a grip portion 61 that is gripped by the user. An openable/closable cover 61a is provided on the upper face of the grip portion 61. More specifically, the lower end portion of the cover 61a is pivoted at the lower end portion of the grip portion 61 so that the cover 61a is rotatable (openable/closable) around this pivot position so as to have a closed state in which the upper face of the grip portion 61 is covered or an open state in which the upper face is exposed.

When the cover 61a is opened, plural buttons B₀₁ to B₁₆ provided on the upper face of the grip portion 61 are exposed. As shown in FIG. 5, the remote controller 60 is connected to the control section 50; when the user operates these buttons B₀₁ to B₁₆, signals corresponding to the operated buttons are transmitted from the remote controller 60 to the control section 50, and the control section 50 controls, based on the signals received, the respective operation units to perform preset operations described below.

First, among the buttons arranged in three vertical columns, the buttons arranged in the left column will be described; by operating the button B₀₁, periodic rubbing massage (rubbing) is performed using the massaging balls 27; by operating the button B₀₂, hand-rubbing-like rubbing massage (hand rubbing) in which the period of rubbing is changed during the massage is performed; and by operating the button B₀₃, periodic pounding massage (pounding 1) is performed using the massaging balls 27. When the button B₀₃ is operated twice, pounding massage in which relatively slow pounding massage and relatively quick pounding massage are repeated alternately at predetermined time intervals is performed (pounding 2). Furthermore, when the button B₀₄ is operated, rubbing and pounding are performed simultaneously; and when the button B₀₅ is operated, some or all of the air cells 7i to 7o provided on the footrest 5 are expanded/contracted to press and massage the legs and feet.

Next, with respect to the buttons arranged in the central column, when the button B₀₆ is operated, massage (W massage) in which the movement speed of the massaging balls is changed during one rubbing operation (for example, a change from low speed to high speed and a change from high speed to low speed) is performed; and when the button B₀₇ is operated, finger-pressure massage using the massaging balls 27 is performed. This finger-pressure massage is attained by displacing the massaging balls 27 so that the movement thereof is made slower than the movement of the massaging balls 27 performed during the pounding massage (pounding 1). Furthermore, when the button B₀₈ is operated, some or all of the air cells 7p to 7s provided in the pillow section 6a and the drooping bands 16a of the head support section 6 are expanded/contracted to press and massage the areas around the shoulders; and when the button B₀₉ is operated, some or all of the air cells 7d to 7h provided in the elbow rest sections 20 of the armrests 4 are expanded/contracted to press and massage the arms. Moreover, when the button B₁₀ is operated, some or all of the air cells 7a to 7c provided in the seat section 2 and the lower portion of the backrest section 3 are expanded/contracted to press and massage the buttocks, the thighs and the lumbar. Still further, when the button B₁₁ is operated, a heater (not shown) disposed in the seat section 2 is activated to perform hyperthermic treatment for warming the buttocks and the thighs.

With respect to the buttons arranged in the right column, when the button B₁₂ is operated, the operation speed of the massaging balls 27, the expanding/contracting speed of the air cells 7a to 7s, etc. can be changed; when the button B₁₃ is operated, the distance between the left and right massaging balls 27 can be adjusted within a predetermined range. In addition, by operating the button B₁₄, rolling massage in which the massaging balls 27 are moved in the up-down direction along the backrest section 3 while being pushed out forward; and by operating the button B₁₅, the back vibrator 8b is driven to perform vibratory massage for the lumbar and the back. Furthermore, when the button B₁₆ is operated, vocal guidance, BGM or the like from a speaker provided in the chair-type massage machine 1 or the remote controller 60 is silenced.

On the other hand, plural buttons A₀₁ to A₁₆ are disposed on the wide upper portion of the remote controller 60 located upward from the grip portion 61, and a display 62 is provided at an upper position from these buttons A₀₁ to A₁₆. When these buttons A₀₁ to A₁₆ are operated, signals corresponding to the operated buttons are transmitted from the remote controller 60 to the control section 50, and the control section 50 controls, based on the signals received, the respective operation units to perform preset operations described below.

More specifically, when the button A₀₁ is operated, a series of massage operations mainly intended to achieve the fatigue recovery of the entire body is performed for a predetermined time using necessary units from among all the operation units of the chair-type massage machine 1 (systemic medical course). When the button A₀₂ is operated, the massaging balls 27 are not operated, and a series of air massage operations, mainly finger-pressure massage, for the entire body of the user is performed for a predetermined time using necessary air cells from among the air cells 7a to 7s (systemic air course). When the button A₀₃ is operated, low-stimulation massage intended to relieve the stiffness of muscles and to alleviate muscle soreness is performed as systemic massage suited in the case that the users are young people ranging from first-year junior high school students to third-year high-school students (young program). Furthermore, when the button A₀₄ is operated, a program for performing general massage on the entire body of the user in a short time is performed (quick course). This quick course will be described later.

In the chair-type massage machine 1 according to this embodiment, when the young program is executed, the backrest section 3 and the footrest 5 are once returned to the initial states thereof, that is, the raised state and the moved-down state, and the backrest section 3 is tilted backward for a predetermined time (for example, three seconds) and the footrest 5 is moved up for a predetermined time (for example, three seconds) from the initial states, and then massage is started using the respective operation units. Hence, massage is possible in a posture suited for a young user, and the tilting angle of the backrest section 3 and the moved-up position of the footrest 5 can be determined properly, without providing angle sensors, by performing operation for the predetermined times after the returning to the initial states is done once.

On the other hand, when the button A₀₅ is operated, massage according to the so-called “centripetal method” is performed to give a further refreshed and awaked feeling after the time of rising from the bed and to eliminate the fatigue of the previous day (good morning course). When the button A₀₆ is operated, massage according to the so-called “centrifugal method” is performed to relieve the fatigue of muscles and the tension of the day before bedtime (good night course). When the button A₀₇ is operated, stretching is performed to refresh the entire body (stretch course). This stretch course will be described later. In addition, when the button A₀₈ is operated, the seat rocking mechanism 31 is driven to rock the buttocks of the user in the left-right direction, thereby giving a relaxed feeling to the user (rocking course).

Furthermore, when the button A₀₉ is operated, the actuator 37 (see FIG. 5) is extended/contracted, thereby being capable of adjusting the reclining angle of the backrest section 3; and when the button A₁₀ is operated, the actuator 39 (see FIG. 5) is extended/contracted, thereby being capable of adjusting the moved-up position (moved-down position) of the footrest 5. Moreover, when the button A₁₁ is operated, air is supplied/exhausted to/from the air cell 28, whereby the front and rear positions of the treatment mechanism 9 can be adjusted; and by operating the button A₁₂, the shoulder positions of the user automatically detected using the massaging balls 27 before each course is performed can be readjusted in the up-down direction by the user themself.

Besides, the button A₁₃ is the main power operation button of the chair-type massage machine 1; by operating this button, the main power is turned on/off; by operating the button A₁₄, all the operations of the chair-type massage machine 1 being performed can be stopped in an emergency. What's more, by operating the button A₁₅, air is exhausted from all the air cells 7a to 7s, whereby these can be contracted; and by operating the button A₁₅, the pressure of all the air cells 7a to 7s at the fully-expanded time can be adjusted.

As described above, by operating the buttons A₀₁ to A₁₆ and the buttons B₀₁ to B₁₆ by the user themself, the user can operate the various kinds of operation units of the chair-type massage machine 1 and can display explanation, guidance, etc. corresponding to the respective operations on the display 62 of the remote controller 60.

[Operation Control Using Control Section]

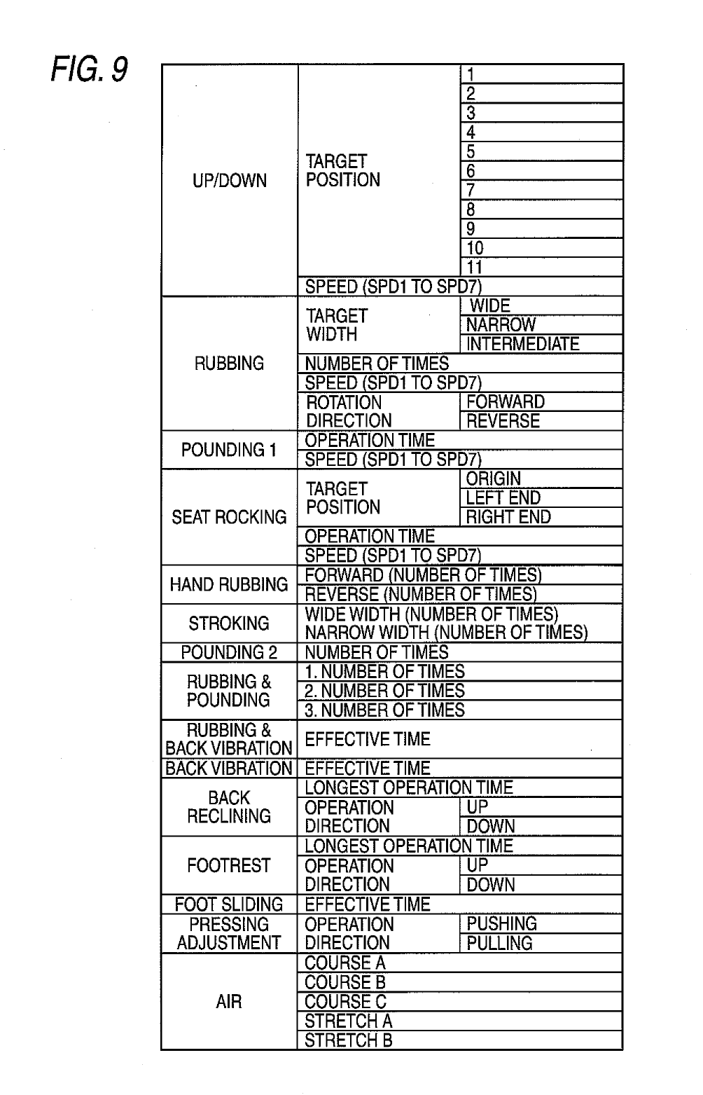

FIG. 9 is a table exemplifying a list of control items that can be performed for the respective operation units of the chair-type massage machine 1 using the control section 50. The control items shown in FIG. 9 will be described in the order in which they appear from the top of the list; first, the control section 50 can set 11 target positions with respect to the up/down positions of the treatment mechanism 9. All these targets correspond to the predetermined finger-pressure points in the back of the upper body of the human, and 11 finger-pressure points are set in the range from around the shoulders to around the lumbar. In addition, when moving up/down the treatment mechanism 9, the control section 50 can set the movement speed thereof in seven steps ranging from the minimum speed (SPD1) to the maximum speed (SPD7).

With respect to the rubbing massage operation, the target width of the distance between the left and right massaging balls 27 of the treatment mechanism 9 can be set in three steps (wide, narrow and intermediate), and the number of rubbing times can be set as desired. In addition, the rubbing speed can be set in seven steps (SPD1 to SPD7), and the rotation direction of a rubbing motor can be set to either forward or reverse. When the rotation direction of the rubbing motor is forward, the massaging balls 27 operate so as to rub a treatment area from outside to inside; when the rotation direction is reverse, the massaging balls operate so as to rub the treatment area from inside to outside.

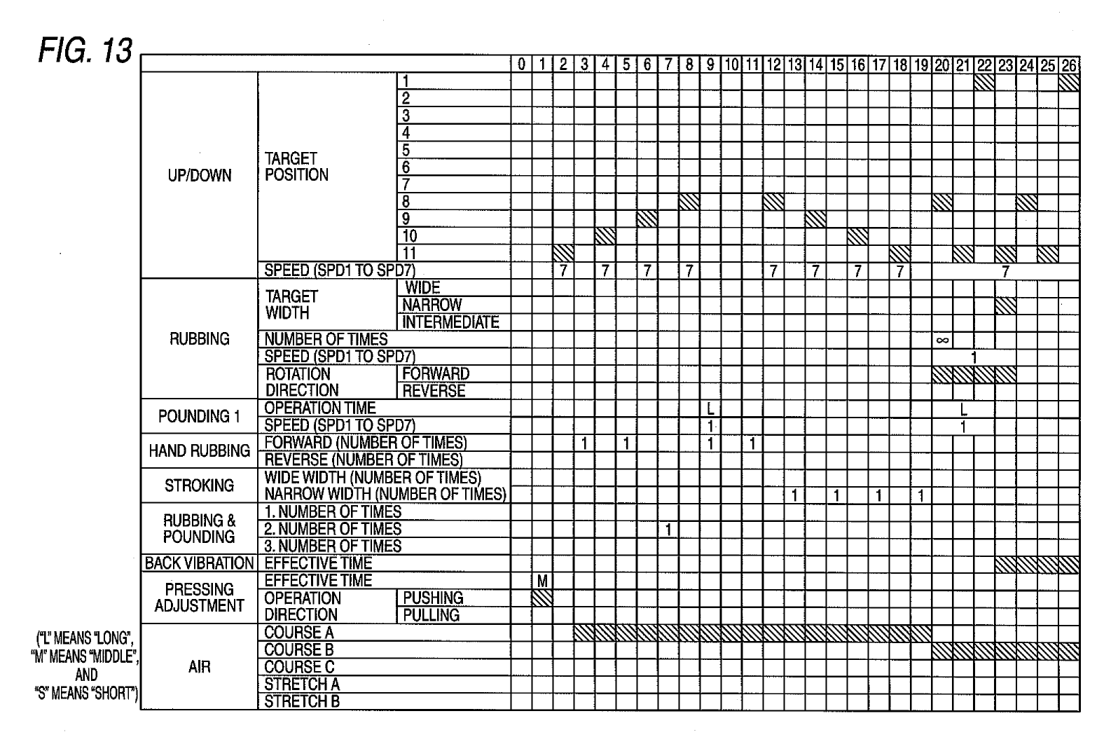

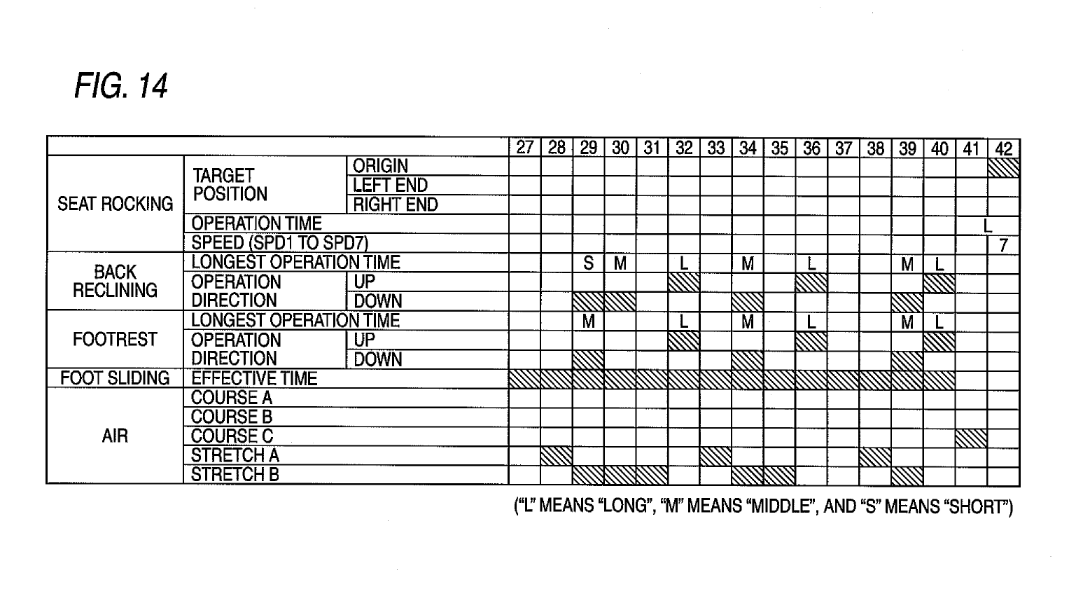

With respect to the massage operation during pounding 1 in which the pounding using the massaging balls 27 is performed in an ordinary cycle, the operation time thereof can be set as desired (with respect to the “operation time” in this embodiment, the operation time being relatively short is represented by “short”, the operation time being relatively long is represented by “long” and the operation time being approximately intermediate between the two is represented by “intermediate”, and the “effective time” can be set similarly (see FIGS. 13 and 14), and the pounding operation can be set in seven steps (SPD1 to SPD7). With respect to the seat rocking operation using the seat rocking mechanism 31, the target positions of the seating face body 10 can be set in three steps (origin, left end and right end), the operation time of the seat rocking mechanism 31 (in other words, the motor 33) can be set as desired, and the operation speed thereof can be set in seven steps (SPD1 to SPD7).

With respect to the hand-rubbing-like massage operation using the massaging balls 27, the rotation direction of the rubbing motor can be set to either forward or reverse; with respect to stroking using the massaging balls 27, the distance between the left and right massaging balls 27 can be set in two steps. Furthermore, with respect to the massage operation during pounding 2 in which pounding is performed at a speed higher than the ordinary speed, the control section 50 can set the number of pounding times at any desired value.

With respect to the massage operation in which rubbing and pounding are performed simultaneously using the massaging balls 27, the number of execution times can be set as desired for respective three patterns preset according to the combination modes of rubbing and pounding. Furthermore, with respect to the massage operation in which rubbing and back vibration are performed simultaneously, the duration time (effective time) thereof can be set as desired; and with respect to the massage operation in which only back vibration is performed, the duration time (effective time) thereof can also be set as desired.

With respect to the reclining operation in which the backrest section 3 is turned, the longest operation time thereof can be set as desired, and the operation direction can be set to moving-up (standing) and moved-down (tilting backward). Similarly, with respect to the turning operation of the footrest 5, the maximum operation time thereof can be set as desired, and the operation direction thereof can be set to moving-up and moved-down.

In addition, with respect to the operation (foot sliding) of the extending/contracting mechanism 40 of the footrest 5, the effective time thereof during which the extension/contraction can be performed can be set as desired; and with respect to the front and rear positions (pushing adjustment) of the treatment mechanism 9, the operation direction thereof can be set to pushing and pulling. Furthermore, with respect to air supplying/exhausting to/from the air cells 7a to 7s, the control section 50 can select a course from among plural courses in which air cells to be used and the air supplying/exhausting timing values thereof are preset and can perform setting.

By virtue of the operation control for the operation units of the chair-type massage machine 1 using the control section 50 as described above, the chair-type massage machine 1 can perform a wide variety of operations. Besides, with respect to the driving of the seat vibrator 8a, the effective time thereof can also be set as desired using the control section 50, although this is not shown in FIG. 9.

Next, some treatments that can be performed using the above-mentioned chair-type massage machine 1 for the user will be described specifically.

[Stretching Operation]

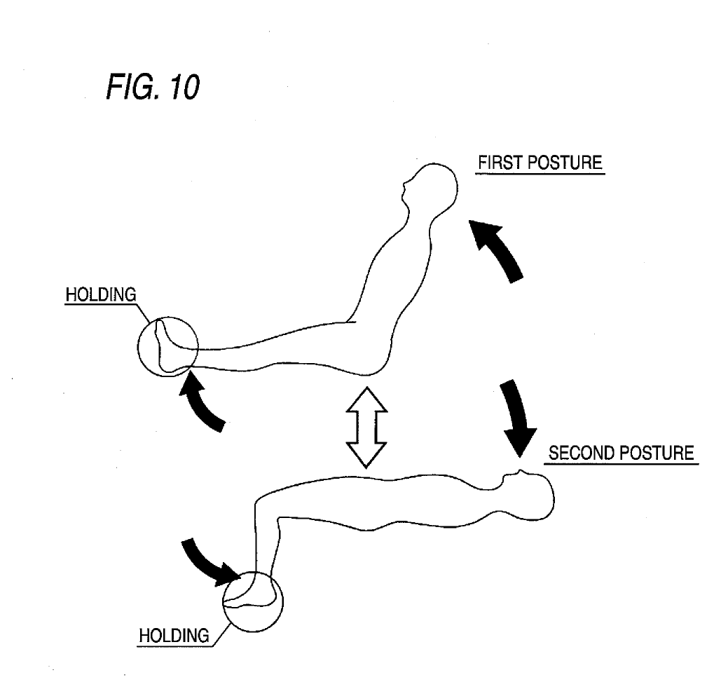

FIG. 10 is a schematic view showing changes in the posture of the user when stretching is performed for the user who is sitting on the seat section 2 and whose upper body is supported on the backrest section 3 to stretch the back muscles. First, in the chair-type massage machine 1, the backrest section 3 is in a state of standing up, and the footrest 5 is in a state of being moved up and nearly horizontal; at this time, the upper body of the user is in a state of being raised and the legs are in a state of being extended straight forward from the thighs to the toes (“first posture” shown in FIG. 10). In addition, the air cells 7l and 7o provided in the footrest 5 are expanded, whereby the ankles and toes are held on the footrest 5.

Next, while the ankles and toes are held, the backrest section 3 is tilted backward and the footrest 5 is moved down. Hence, the upper body of the user is tilted backward and the lower legs are bent downward with respect to the thighs while the knees are used as base points, whereby the entire body is in a posture of being bent backward (“second posture” shown in FIG. 10). As a result, the user, in particular, the upper body, is bent backward (as viewed from the user) and the back muscles are extended and stretched.

The backward tilting operation of the backrest section 3 and the moving-down operation of the footrest 5 are not required to be performed simultaneously; for example, stretching can also be performed by tilting the backrest section 3 backward after the footrest 5 is moved down. In this case, when the footrest 5 is moved down, the legs of the user are bent at around the knees, the backrest section 3 is tilted backward while the lower legs are held; hence, the upper body of the user tends to be displaced in the direction of the top of the head, whereby stretching can be performed so that the entire body is extended. Furthermore, due to the friction between the front face (the back receiving face) of the backrest section 3 and the back of the user making contact therewith, the displacement of the upper body toward the lower legs is restricted, whereby the upper body tends to be displaced easily toward the top of the head and the entire body can be stretched properly.

Furthermore, as the backrest section 3 is tilted backward, by the expansion of some or all of the air cells 7p corresponding to the neck, the air cells 7g corresponding to the shoulders, the air cells 7d to 7h corresponding to the arms and the air cells 7b corresponding to the side portions of the buttocks, the displacement of the upper body toward the lower legs can be restricted more effectively while the upper body (the neck, shoulders and arms) and the buttocks of the user are held, whereby the effect of stretching can be improved further.

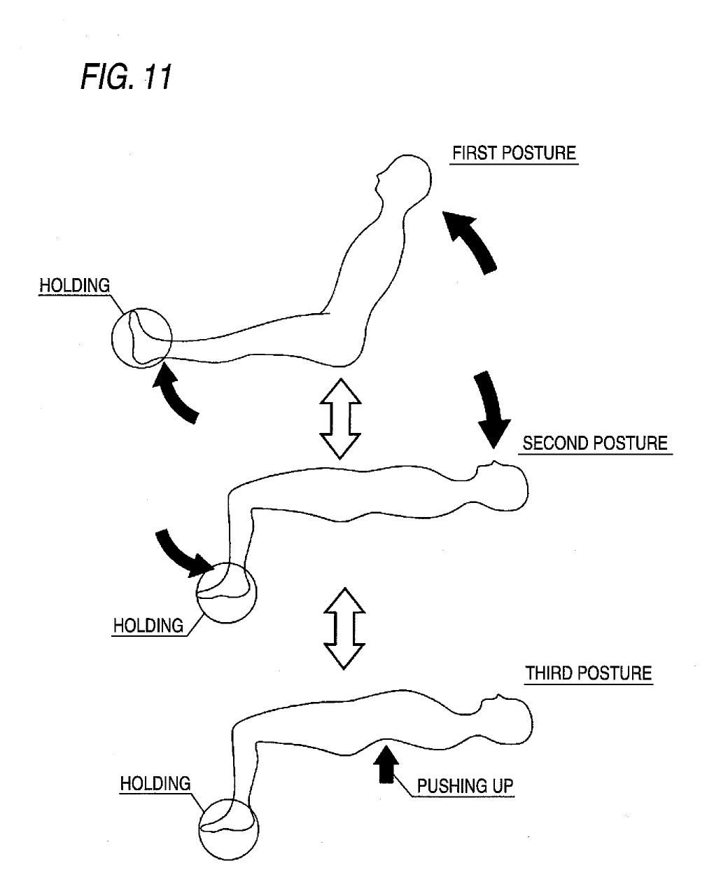

FIG. 11 is a schematic view showing changes in the posture of the user when another type of stretching is performed to stretch the back muscles of the user. In FIG. 11, the first posture and the second posture are similar to those described in FIG. 10. In the stretching shown in FIG. 11, by the expansion of the air cells (finger-pressure portions) 7c provided in the lower portion of the backrest section 3, the area around the lumbar of the user lying on the back is pressed so as to be pushed upward from the state where the user is in the second posture. Hence, the user is in a posture of being bent backward (“third posture” shown in FIG. 11) so that the user, in particular, the upper body, is further bent backward, whereby the effect of stretching is improved.

The area around the lumbar is pushed up by expanding the air cells 7c in this case; however, instead of expanding the air cells 7c, by expanding the air cell 28 disposed behind the treatment mechanism 9 while the treatment mechanism is positioned around the lumbar so as to push out the treatment mechanism 9 toward the user, the area around the lumbar can be pushed up using the massaging balls 27. Furthermore, rubbing operation can also be performed using the massaging balls 27 by driving the treatment mechanism 9 at the same time when the area around the lumbar is pushed up using the massaging balls 27; in this case, rubbing massage around the lumbar can be performed together with stretching that is performed by pushing up the area around the lumbar.

Moreover, when the air cells 7c (or the air cell 28) are expanded/contracted (minutely vibrated) in a short cycle while the user is in the third posture, further improvement in the effect of stretching can be expected. For this kind of minute vibration, the vibration operation obtained by driving the back vibrator 8b may also be adopted or the pounding operation and the rubbing operation using the massaging balls 27 may also be adopted. Still further, when the lumbar is pushed up so that the user is set in the third posture, some or all of the above-mentioned air cells 7d to 7h and 7p may be expanded to hold the upper body and the buttocks; by this holding, the central portion of the body in the left-right direction is pushed up while the side portions of the body are held, whereby further improvement in the effect of stretching can be expected.

Furthermore, since the chair-type massage machine 1 according to this embodiment includes the seat rocking mechanism 31 for rocking the seating face body 10 in the left-right direction, the buttocks of the user may be rocked for a certain time in the left-right direction by operating the seat rocking mechanism 31 before the stretching operations shown in FIGS. 10 and 11. This rocking of the buttocks is effective in relaxing the user mentally and physically as if the user is rocked in an easy chair or a hammock; hence, the user can be eased and relaxed by performing this rocking before stretching, whereby the effect of stretching thereafter can be improved.

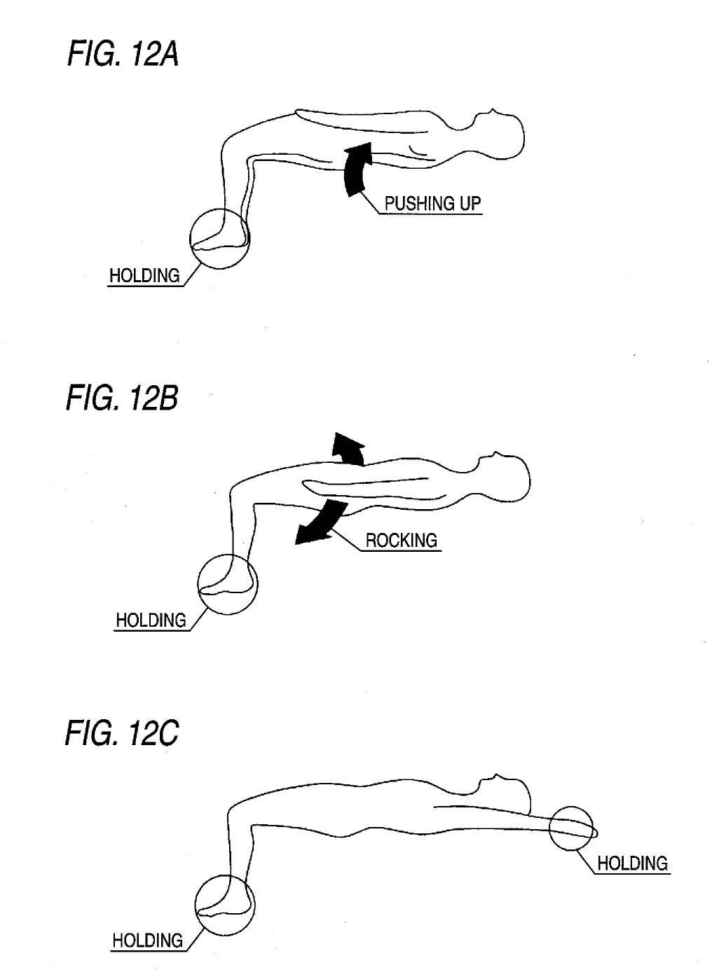

FIGS. 12A to 12C are schematic views showing changes in the posture of the user when still another type of stretching is performed to stretch the back muscles of the user. In the example shown in FIG. 12A, the backrest section 3 is tilted backward and the footrest 5 is moved down, and the ankles and toes are held by the expansion of the air cells 7l and 7o, whereby a state similar to that of the second posture shown in FIG. 10 is obtained. Furthermore, in this state, while one of the left and right air cells 7c provided at the lower portion of the backrest section 3 is contracted, when the other is expanded, the lumbar of the user is pushed up using one of the left and right air cells, whereby the upper body is stretched so as to be twisted. Furthermore, stretching may also be performed so that the upper body is twisted in the right direction and in the left direction sequentially by expanding and contracting the left and right air cells 7c so that the timings of the expansion and the contraction are reversed mutually.

In the example shown in FIG. 12B, from a state similar to that of the second posture shown in FIG. 10, the seat rocking mechanism 31 is driven and the seating face body 10 is reciprocated in the left-right direction, thereby rocking the buttocks of the user placed thereon in the left-right direction. The rocking of the buttocks in the left-right direction as described above can also be attained by alternately expanding/contracting the air cells 7b and 7b disposed on the left and right sides so that the order of the expansion and the contraction is reversed mutually. In addition, the buttocks may also be pressed so as to be pushed up by expanding the air cells 7a provided in the seat section 2. Furthermore, the stretching in the third posture (shown in FIG. 11) and the rocking of the buttocks may also be combined and performed by expanding the air cells 7c at the same time when the rocking of the buttocks is performed. Hence, the buttocks are rocked while the user is in a backwardly bent posture, and improvement in the effect of stretching can be expected. As described above, improvement in the effect of stretching the user can be attained using the control section 50 by independently controlling and appropriately combining the stretching by the tilting of the backrest section 3 backward, the rocking of the buttocks by driving the seat rocking mechanism 31 and the pushing up of the lumbar using the air cells 7c or the treatment mechanism 9.

In the example shown in FIG. 12C, in addition to the second posture shown in FIG. 10, the areas around the wrists of the arms are held while being raised as the banzai-like posture. With this posture, the entire body of the user is extended further, and improvement in the effect of stretching can be expected. Units for holding the areas around the wrists should only be designed so as to support the wrists by installing concave members being open forward and used to receive the wrists on both side portions of the upper portion of the backrest section 3, or other units may be used to hold the wrists. With respect to the order of the holding of the wrists and the backward tilting of the backrest section 3, a higher stretching effect can be obtained by first holding the wrists at the top of the head and then by tilting the backrest section 3 backward. Furthermore, the stretching operations shown in FIGS. 10, 11, 12A and 12B may be combined with the stretching operation shown in FIG. 12C.

In the stretching operations shown in FIGS. 10 to 12 described above, the footrest 5 is moved down until it becomes nearly vertical, whereby the user takes a posture in which the lower legs are bent nearly perpendicular with respect to the thighs; however, it is not always necessary to adjust the footrest 5 to the most moved-down position. In other words, the footrest 5 may be positioned so as to be slightly higher than this position, and a posture in which the legs of the user are bent moderately at around the knees may be taken.

Furthermore, in addition to the stretching operations in the above-mentioned modes, rolling massage in which the treatment mechanism 9 is moved up and/or moved down along the backrest section 3 while the user takes the posture shown in FIG. 10 may be performed; this can also perform stretching to extend the back muscles. In particular, by performing rolling massage in which the treatment mechanism 9 is raised from a position corresponding to the area around the lumbar, effective stretching can be attained. Furthermore, during the reclining operation of the backrest section 3 from the standing state to the backward tilting state, the treatment mechanism 9 may be moved up from a lower position corresponding to the area around the lumbar or moved down from an upper position while the air cell 28 is expanded and the massaging balls 27 are pressed against the back of the user. This can also attain stretching to extend the back muscles of the user.

[Quick Course]

FIGS. 13 and 14 are tables showing specific operation control performed by the control section 50 in the quick course referred in the description of FIG. 8, and the horizontal axis thereof represents steps 0 to 42 to be executed in consecutive time order. In the quick course exemplified herein, a predetermined course, course A, is performed at steps 3 to 19, and another course, course B, is performed at steps 20 to 26; furthermore, the combination of stretch A and stretch B is performed intermittently at steps 28 to 39, and course C is finally performed at step 41.

More specifically, as shown in FIG. 13, beginning from the initial state at step 0, the treatment mechanism 9 is moved in the pushing direction for a short time (effective time: “intermediate”) (at step 1). Next, the treatment mechanism 9 located at the lowest position is moved up at the maximum speed (SPD7) at steps 2, 4, 6 and 8 sequentially, step by step, and reaches a position corresponding to the fourth finger-pressure point 8 and then is moved down at the maximum speed (SPD7) at steps 12, 14, 16 and 18 sequentially, step by step, thereby returning to the lowest position. During this operation, the massaging balls 27 perform hand-rubbing-like rubbing massage (forward rotation: once for each) at steps 3 and 5 in which the treatment mechanism 9 is not moved up/down but stopped, perform massage (once) in which rubbing and pounding are performed in conjunction with each other at step 7, perform massage in which pounding 1 and hand rubbing (forward rotation: once) are performed in conjunction with each other at the minimum speed at step 9, perform only hand-rubbing-like massage (forward rotation: once) at step 11, and perform stroking massage at steps 13, 15, 17 and 19. Stroking is an operation to stroke the back or the lumbar of the user by rocking the massaging balls 27 a predetermined number of times in the left-right direction. Furthermore, in the period between the start of the hand-rubbing massage at step 3 and the completion of the stroking massage at step 19, pressure massage using the air cells 7a to 7s having been preset is also performed simultaneously as course A.

Next, in the period between steps 20 and 26, pressure massage using the air cells 7a to 7s having been preset is also performed as course B in another mode; during this period, the treatment mechanism 9 is sequentially moved to the position corresponding to the fourth finger-pressure point 8 from the lowest point (at step 20), to a position corresponding to the lowest finger-pressure point 11 (at step 21), to a position corresponding to the highest finger-pressure point 1 (at step 22), to the position corresponding to the lowest finger-pressure point 11 (at step 23), to the position corresponding to the fourth finger-pressure point 8 from the lowest point (at step 24), to the position corresponding to the lowest finger-pressure point 11 (at step 25), and to the position corresponding to the highest finger-pressure point 1 (at step 26). Furthermore, the massaging balls 27 perform rubbing massage (forward rotation) at the minimum speed (SPD1) in the period between steps 20 and 23, and perform, at the same time, pounding 1 massage at the minimum speed (SPD1) at steps 20 to 22. Moreover, vibratory massage using the back vibrator 8b is performed in the period between steps 23 and 26 after pounding 1 massage.

When a series of massage operations described above using the air cells 7a to 7s, the massaging balls 27 and the back vibrator 8b is completed, operations for stretching the entire body of the user are then performed at steps 27 to 41. Although the number of operation times can be set for rubbing, hand rubbing, stroking and rubbing & pounding (see FIG. 9), the number of times can be set to not only 1 but also a desired value, as a matter of course.

More specifically, as shown in FIG. 14, first, a state (flat sliding: effective) in which the footrest 5 can be extended/contracted is obtained in the period between steps 27 and 40, and stretch A is performed at step 28. An operation for holding the ankles by the expansion of the air cells 7l is set as stretch A. At the next step 29, the footrest 5 is moved down for an intermediate time (operation time: “intermediate”), and during this period, the backrest section 3 is tilted backward for a short time (operation time: “short”). When the moving down of the footrest 5 is completed, the backrest section 3 is further tilted backward for an intermediate time (operation time: “intermediate”), and the backrest section 3 is in a state of being most tilted backward. In addition, stretch B is performed during the operations of the backrest section 3 and the footrest 5 at steps 29 and 30, and at the next step 31 in which the backrest section 3 and the footrest 5 are stopped. As stretch B, an operation for holding the toes by the expansion of the air cells 7c is set.

Hence, since the backrest section 3 is tilted backward and the footrest 5 is moved down while the toes are held in the period between steps 29 and 31, the user is held in a state similar to the second posture described using FIG. 10 and can bodily feel, stretching such that the back muscles are extended. Since this stretching operation is performed at two separate steps: step 29 in which the backward tilting operation of the backrest section 3 is performed simultaneously with the moving-down operation of the footrest 5 for a short time and step 30 in which the backward tilting operation is performed for an intermediate time while the footrest 5 is stopped, the burden applied to the user is small, and the stretching operation is appropriate as that performed first among the series of stretching operations.

At the next step 32, the backrest section 3 is tilted forward and raised for a long time (operation time: “long”) and the footrest 5 is moved up for a long time (operation time: “long”). Hence, the user is in a state similar to the first posture described using the FIG. 10, thereby being relieved once from the stretched state.

Next, after the ankles are held by expanding the air cells 7l again at step 33, the air cells 7c are expanded to hold the toes at steps 34 and 35. Furthermore, at step 34, the backrest section 3 is tilted backward for an intermediate time (operation time: “intermediate”) and the footrest 5 is moved down for a similar time while the toes are held, whereby the user has a posture similar to the second posture (see FIG. 10). In this way, in the second stretching operation, the backward tilting operation of the backrest section 3 and the moving-down operation of the footrest 5 are performed simultaneously for a similar time, whereby the user can obtain a stretching feeling slightly stronger than that during the first stretching operation.

Then, at step 36, the backrest section 3 is tilted forward and raised for a long time (operation time: “long”) and the footrest 5 is moved up for a long time (operation time: “long”) as in the case of step 32. Hence, the user is relieved from the stretched state.

Subsequently, after step 37 in which the backrest section 3, the footrest 5 and air cells 7a to 7s are all inoperative, the ankles are held by stretch A (at step 38), and then, the toes are held by stretch B (at step 39). At this step 39, the backrest section 3 is tilted backward for an intermediate time (operation time: “intermediate”) and the footrest 5 is moved down for a similar time while the toes are held, whereby the user has a posture similar to the second posture (see FIG. 10) and can feel a slightly stronger stretching feeling.

Next, at step 40, the backrest section 3 is tilted forward and raised for a long time (operation time: “long”) and the footrest 5 is moved up for a long time (operation time: “long”) as in the cases of steps 32 and 36. Hence, the user is relieved from the stretched state. After the completion of step 40, the stretching operation of the chair-type massage machine 1 for the user is completed. Then, after the completion of the stretching operation, the appropriate areas of the user are pressure-treated by appropriately expanding/contracting the air cells 7a to 7s, and the buttocks of the user are rocked in the left-right direction by driving the seat rocking mechanism 31 at the maximum speed (SPD7), whereby the user can obtain a relaxed feeling (at step 41). Then finally, the seating face body 10 is returned to its origin position (at step 42).

As described above, the muscles of the entire body of the user can be softened by stretching the entire body after pressure massage, such as rubbing and pounding; furthermore, the muscles of the user can be softened further by driving the seat rocking mechanism 31 to rock the buttocks after the stretching.

Although FIG. 14 shows an example in which the stretching operation is performed intermittently three times, the number of times may be two or four. In addition, after the completion of the backward tilting of the backrest section 3, the lumbar may be pushed upward, the upper body may be twisted or the buttocks may be rocked in the left-right direction as described using FIGS. 11 and 12, and the backrest section 3 may be tilted backward while the wrists are held at the top of the head, as a matter of course. Furthermore, although the cases in which the ankles and toes are held are described in the above-mentioned stretching operations, only the ankles or the toes may be held, or the calves may be held using the air cells 7j and 7k.

[Another Configuration of Chair-Type Massage Machine]

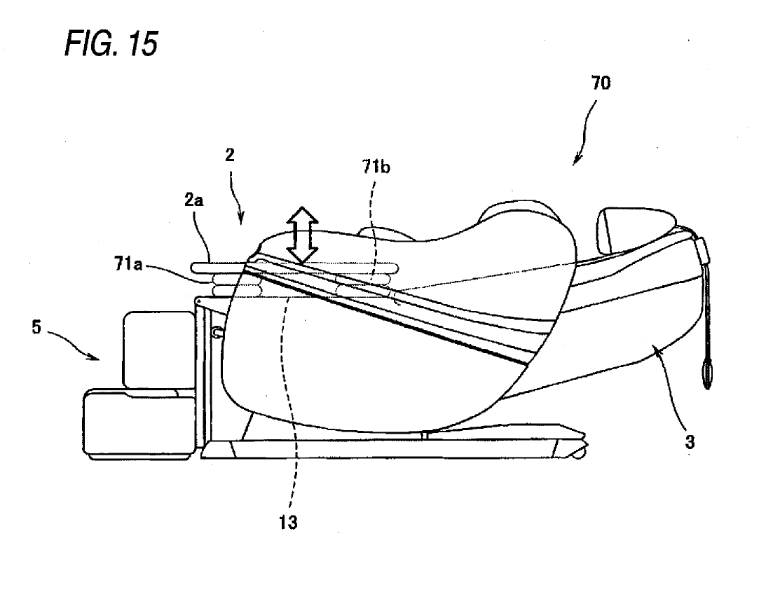

FIG. 15 is a side view showing another configuration of the chair-type massage machine capable of stretching the back muscles of the user. The chair-type massage machine 70 shown in FIG. 15 has a configuration almost similar to the above-mentioned chair-type massage machine 1, but is different in that the upper face of the seat section 2 can be moved up and down.

When described in more detail, the seat section 2 of the chair-type massage machine 70 is configured so that a seat cushion 2a for stably supporting the buttocks and thighs of the user is disposed above the seat frame 13 serving as a framework. In addition, between the seat frame 13 and the seat cushion 2a, the air cells 71a and 71b are provided at the front portion and the rear portion. In this embodiment, these air cells 71a and 71b are expanded and contracted by air supplying/exhausting of the air supplying/exhausting apparatus 51 shown in FIG. 5; when they are expanded, the seat cushion 2a can be moved upward by a predetermined distance while its posture (in other words, the posture obtained while the air cells 71a and 71b are contracted) is maintained.

With the thus-configured chair-type massage machine 70, the upper face of the rear portion of the seat section 2 is positioned above the upper face of the lower portion of the backrest section 3 and the buttocks of the user lying on the back can be pressed so as to be pushed upward by tilting the backrest section 3 backward while the user sits and by expanding the air cells 71a and 71b while the footrest 5 is positioned downward. Hence, as in the third posture shown in FIG. 11, the user, in particular, the upper body, is stretched in a backward bending posture so as to be bent backward (downward in this case).

Although the case in which by the expansion of the air cells 71a and 71b the seat cushion 2a is moved up while its posture is maintained is described above, the posture of the seat cushion 2a may be changed slightly. For example, by the expansion of the air cells 71a and 71b, the relative position (the position in the up-down direction) of the rear portion with respect to the front portion of the upper face of the seat cushion 2a may be moved up. In addition, it may be configured so that the air cell 71a on the front side is omitted, only the air cell 71b on the rear side is used, and only the rear portion of the seat cushion 2a close to the lumbar is moved up by expanding the air cell. After all, a difference in level should only be formed so that the upper face of the seat section 2 is positioned above the upper face of the backrest section 3 at the boundary portion between the seat section 2 and the backrest section 3. With this configuration, the user can be stretched so as to be bent backward.

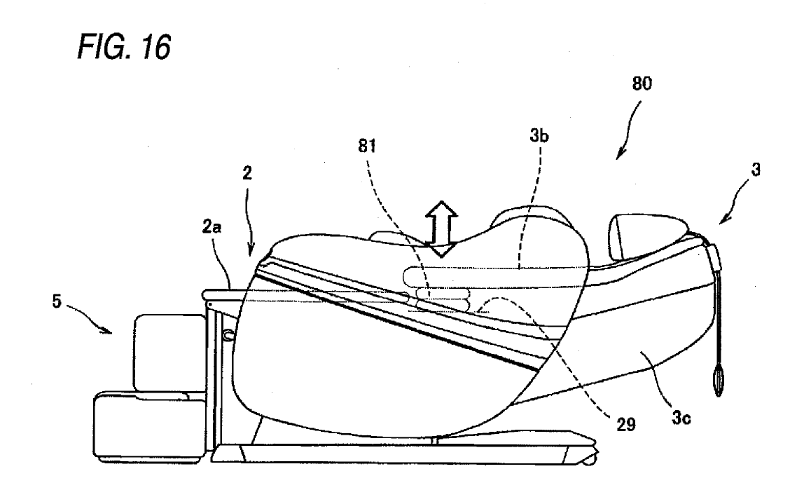

FIG. 16 is a side view showing still another configuration of the chair-type massage machine capable of stretching the back muscles of the user. The chair-type massage machine 80 shown in FIG. 16 has a configuration almost similar to the chair-type massage machine 1 described already, but is different in that the upper face of the backrest section 3 tilted backward can be moved up and down.

When described in more detail, the backrest section 3 of the chair-type massage machine 80 is configured so that a back cushion 3b for stably supporting the upper body of the user is disposed on the front side of the back frame 29 (part thereof is shown) serving as a framework and the rear portion of the back frame 29 is covered with a backrest case 3c. In addition, between the lower portion of the back frame 29 and the back cushion 3b, an air cell 81 is provided. In this embodiment, this air cell 81 is expanded and contracted by air supplying/exhausting of the air supplying/exhausting apparatus 51 shown in FIG. 5; when the air cell is expanded, the lower portion of the backrest case 3b can be moved in a direction of being separated from the back frame 29.

With the thus-configured chair-type massage machine 80, a difference in level is formed at the boundary portion between the seat section 2 and the backrest section 3 so that the upper face of the lower portion of the backrest section 3 is positioned above the upper face of the rear portion of the seat section 2 by tilting the backrest section 3 backward while the user sits and by expanding the air cell 81 while the footrest 5 is positioned downward, whereby the area around the lumbar of the user lying on the back can be pressed so as to be pushed upward. Hence, as in the third posture shown in FIG. 11, the user, in particular, the upper body, is stretched in a backward bending posture so as to be bent backward (downward in this case).

At the time of the stretching operations shown in FIGS. 15 and 16 described above, the lower legs of the user can be supported by expanding the air cells 7i to 7o provided in the footrest 5. Furthermore, when the lower legs are supported as described above, improvement in the effect of stretching for the user can be expected by moving the seat cushion 2a or the back cushion 3b as described above.

Furthermore, although the case in which stretching is performed while the footrest 5 is in a moved-down state is described in the above-mentioned description, it is not always necessary to maintain the footrest 5 at the moved-down state, but the seat cushion 2a or the back cushion 3b may be moved while the footrest 5 is in a moved-up state as shown in FIG. 7B, for example. Even in this case, the effect of stretching the user by bending the upper body backward can be expected.

Moreover, stretching can be performed for the user by combining the configuration shown in FIG. 15 with the configuration shown in FIG. 16 without forming any difference in level at the boundary portion between the seat section 2 and the backrest section 3. For example, while the air cell 71a on the front side of the seat section 2 is contracted, the air cell 71b on the rear side is expanded and the air cell 81 provided in the backrest section 3 is expanded. Hence, the rear portion of the seat cushion 2a is tilted so as to be positioned above the front portion thereof, and the lower portion of the back cushion 3b is in a state of being raised. As a result, although no difference in level is formed at the boundary portion between the seat section 2 and the backrest section 3, the buttocks or the lumbar of the user is pushed upward, and stretching can be performed for the user. Even in this case, a certain stretching effect can be expected even when the footrest 5 is in the moved-down state shown in FIG. 7B; however, a further stretching effect can be expected in the moved-up state shown in FIG. 7A.

### Embodiment 2

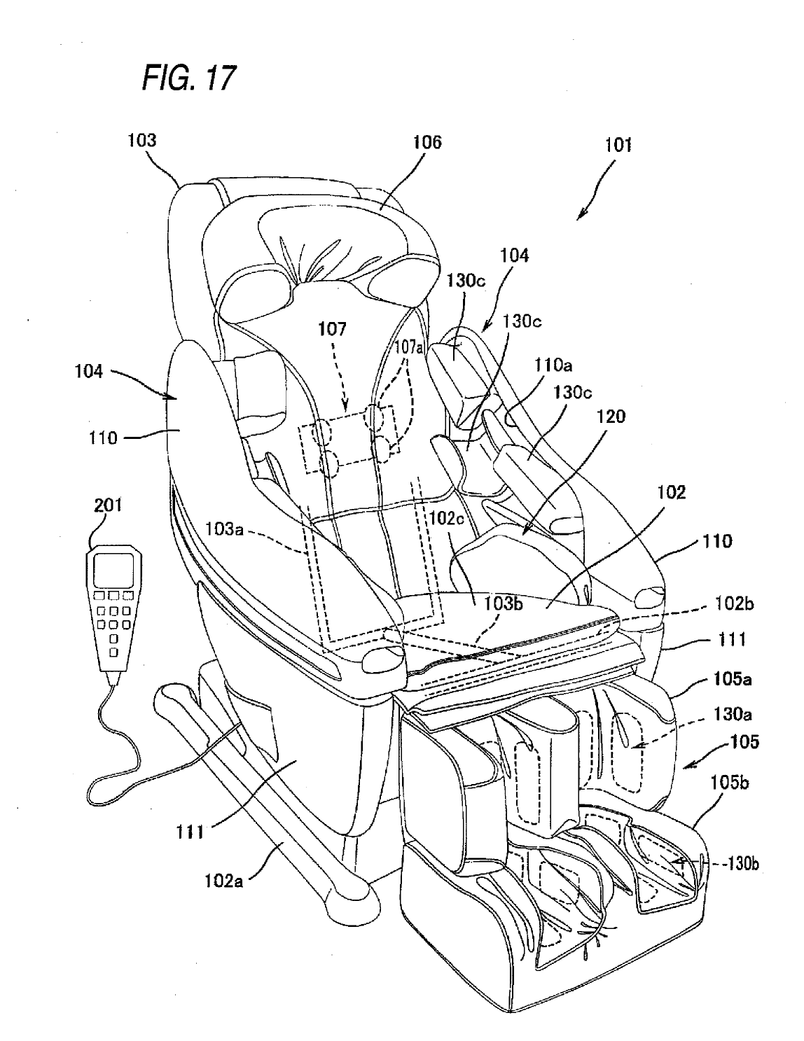

A chair-type massage machine according to Embodiment 2 of the present invention will be described below specifically referring to the drawings. FIG. 17 is a perspective view showing an overall configuration of the chair-type massage machine according to Embodiment 2 of the present invention. As shown in FIG. 17, the chair-type massage machine 101 mainly includes a seat section 102 on which the user sits, a backrest section 103 for supporting the upper body of the user from behind, armrests 104 for supporting the arms of the user, and a footrests 105 for supporting the legs of the user. It is herein assumed that the concept of the directions used in the following description coincides with the concept of the directions as viewed from the user sitting on the seat section 102 and that other cases will be explained as necessary.

[Overall Configuration]

The seat section 102 is configured so that a cushion section 102c formed nearly flat is disposed above a seat frame 102b (part thereof is shown in FIG. 17) provided above a base 102a. This cushion section 102c is configured so that an interior material, such as urethane foam, sponge or styrene foam, is covered with an exterior cover formed of raised tricot made of polyester, synthetic leather or natural leather.

The footrest 105 for treating the lower legs ranging from the knees to the toes of the user are disposed on the front side of the seat section 102. This footrest 105 is formed into a nearly L-shape in side view and includes an upper footrest 105a corresponding to the portions ranging from the knees to the ankles, mainly the calves, and a lower footrest 105b corresponding to the portions ranging from the ankles to the toes, these being respectively provided for the right and left legs.

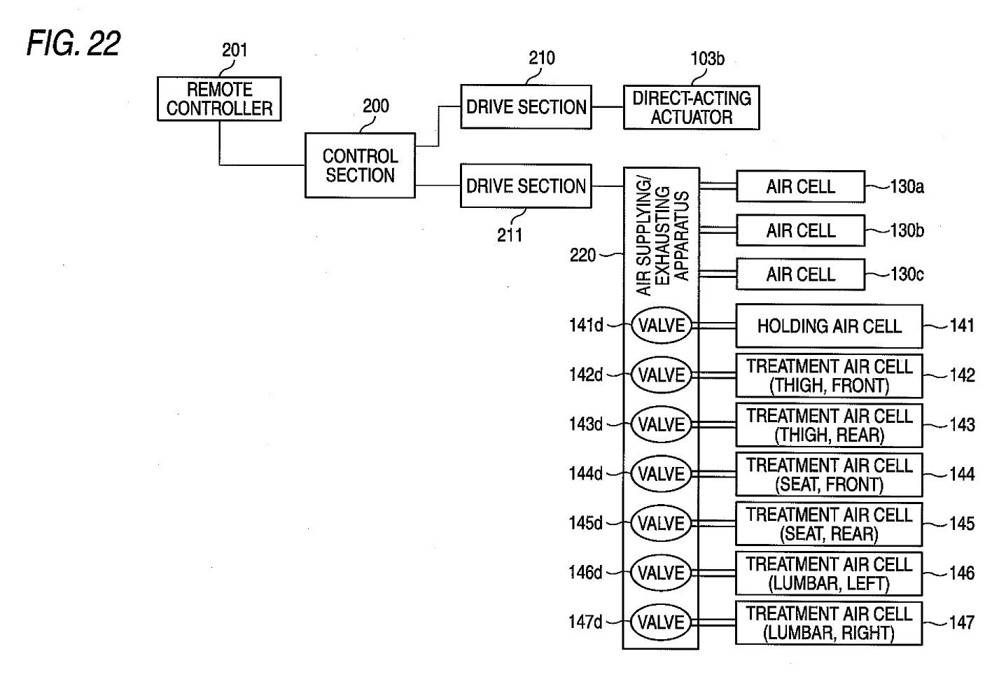

The upper footrest 105a is grooved in shape so as to be open forward, and on the back face and the left and right side faces thereof, air cells 130a (also see FIG. 22) that are expanded and contracted by supplying/exhausting air are respectively provided so as to correspond to the back faces and the left and right side faces of the calves, whereby the calves can be pressure-treated from behind and from the left and right sides. Furthermore, the lower footrest 105b is grooved in shape so as to be open upward, and on the bottom face and both the left and right side faces thereof, air cells 130b (also see FIG. 22) that are expanded/contracted by supplying/exhausting air are respectively provided so as to correspond to the soles, the insteps and the side faces of the ankles, whereby these portions can be pressure-treated.

The backrest section 103 for supporting the upper body of the user is provided on the rear side of the seat section 102. In order to support the upper body of the user, the backrest section 103 is designed to have a size to the extent that when an average-built adult sits on the chair-type massage machine 101, no part of the body of the adult protrudes from the outside thereof, and is formed into a vertically-elongated nearly rectangular shape in front view. Furthermore, above this backrest section 103, a pillow section 106 is disposed so as to correspond to the head of the user whose upper body is supported on the backrest section 103.

In addition, a rectangular-shaped back frame 103a is built inside the backrest section 103, and this back frame 103a is turnably pivoted around the seat frame 102b provided below the seat section 102 at a position slightly above the lower end portion thereof. On the other hand, one end of a direct-acting actuator 103b (also see FIG. 22) formed of an air cylinder or the like is connected to the lower end portion of the back frame 103a, and the other end thereof is connected to the front portion of the seat frame 102b. Hence, the upper portion of the backrest section 103 can be turned in the front-rear direction around the pivoting position thereof by extending and contracting the direct-acting actuator 103b, in particular, can be tilted backward by contracting the direct-acting actuator 103b.

Furthermore, a mechanical massaging mechanism 107 having treatment devices 107a is accommodated inside the backrest section 103. This massaging mechanism 107 can be reciprocated in the longitudinal direction of the backrest section 103 along a guide rail (not shown) extending in the up-down direction and can perform massage operations such as rubbing, pounding and rolling, for the upper body of the user according to instructions from a control section 200 (see FIG. 22).

On both sides of the seat section 102 and the backrest section 103, the armrests 104 for supporting the arms of the user sitting on the seat section 102 are disposed so as to be extended forward along the seat section 102 from the side positions of the backrest section 103. The armrest 104 is formed of an elbow rest section 110 and a Side cover 111 disposed therebelow. The elbow rest section 110 has a nearly cylindrical shape and is extended from a position slightly above the vertically central portion of the backrest section 103 being in a raised state to the vicinity of the front end of the seat section 102 downward and forward. Furthermore, since an opening 110a allowing an arm of the user to be inserted/extracted is formed inside the rear portion of the elbow rest section 110, the arm of the user inserted into the inside through this opening 110a can be supported in the range from the fingers to the upper arm and the shoulder via the elbow. Moreover, plural air cells 130c (also see FIG. 22) are disposed on the inner wall face of the elbow rest section 110 in the range from the front portion to the rear portion thereof, whereby the entire arm of the user can be pressure-treated using the air cells 130c.

Still further, thigh treatment sections 120 extending in the front-rear direction are disposed inside (on the central side of the chair-type massage machine 101 in the width direction thereof) the left and right armrests 104 around the left and right side portions of the seat section 102. These thigh treatment sections 120 are configured as described later so as to be able to pressure-treat the thighs from the outside while holding the thighs.

[Configuration of Treatment Section]

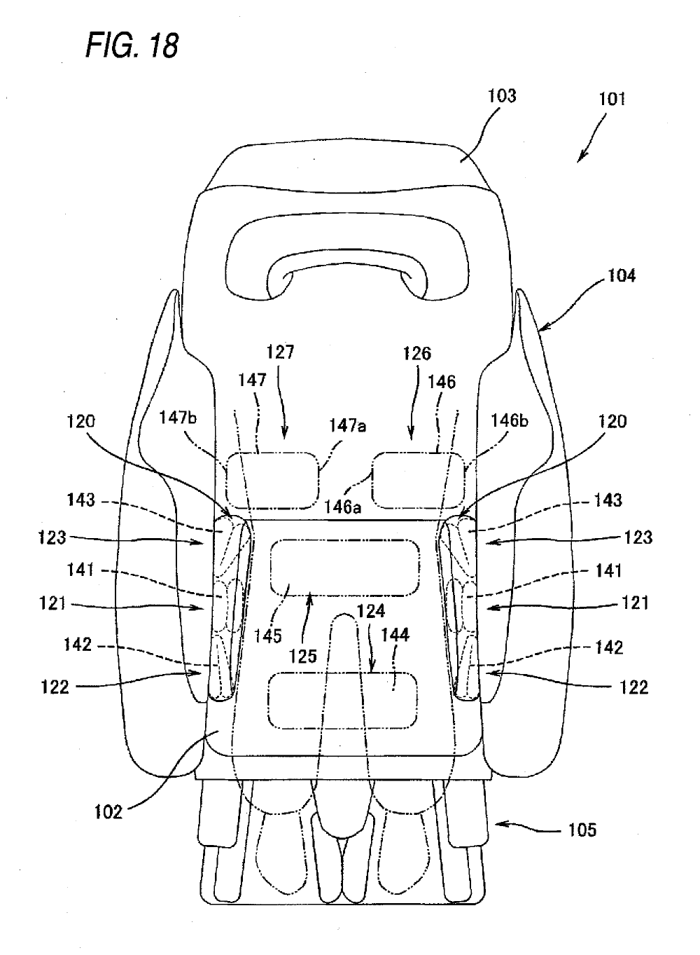

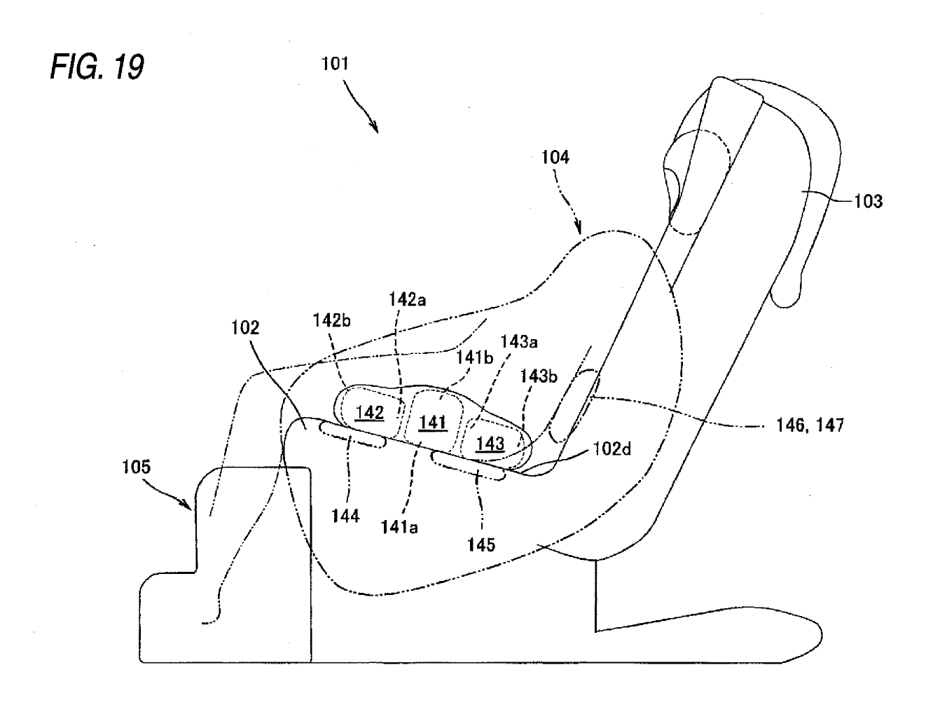

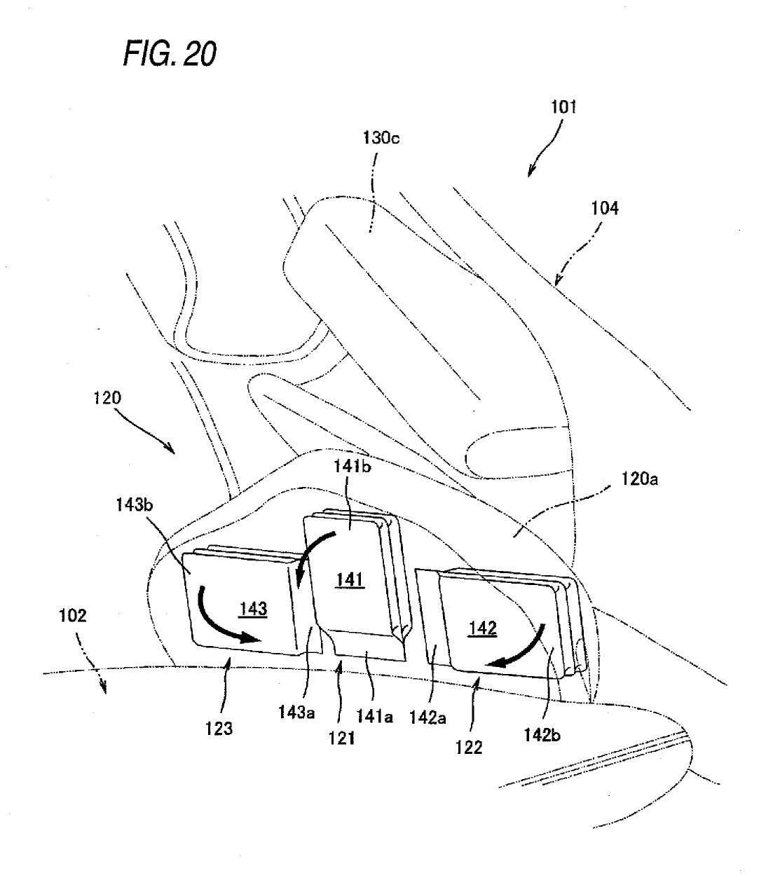

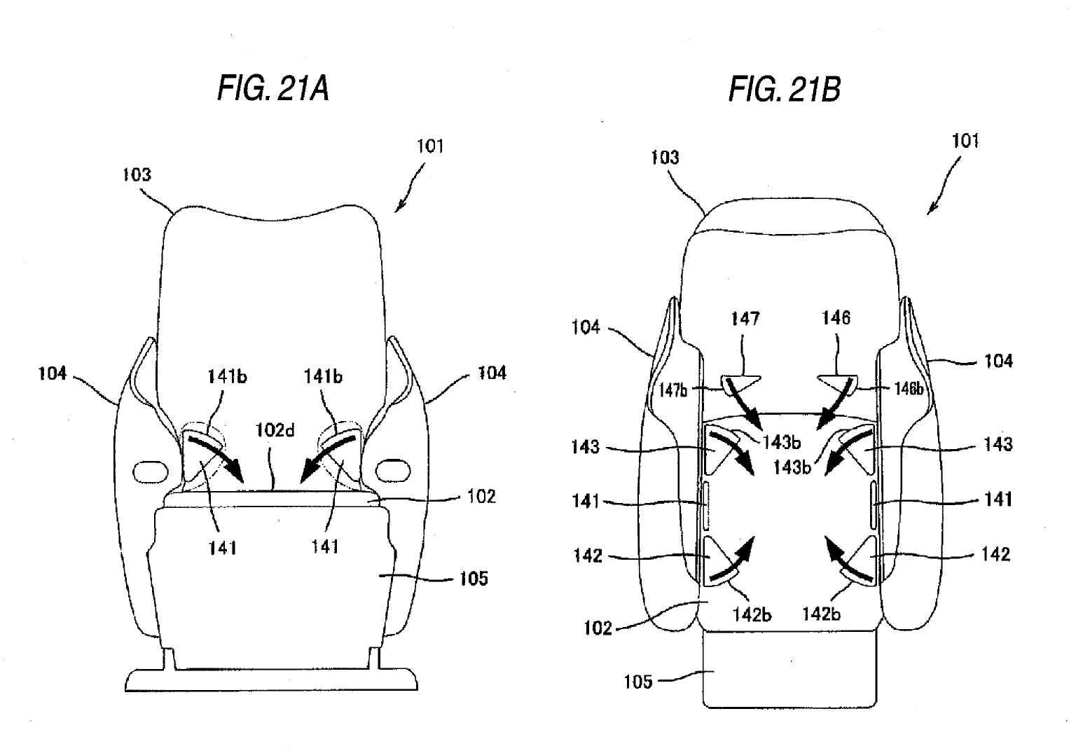

FIG. 18 is a plan view showing the configuration of the chair-type massage machine 101, shown in FIG. 17, for mainly treating the thighs of the user using the thigh treatment sections 120, etc., FIG. 19 is a side view showing the chair-type massage machine 101 shown in FIG. 18, FIG. 20 is an enlarged view showing the thigh treatment sections 120 shown in FIG. 18, and FIGS. 21A and 21B are schematic views for illustrating the operations of the air cells provided in the respective sections, FIG. 21A being a front view of the chair-type massage machine 101, FIG. 21B being a side view thereof.

As shown in FIG. 18, the thigh treatment sections 120 extending in the front-rear direction are disposed inside (on the central side of the chair-type massage machine 101 in the width direction thereof) the left and right armrests 104 around the left and right side portions of the seat section 102. These thigh treatment sections 120 each includes three air cells disposed along the front-rear direction. More specifically, the thigh treatment sections each includes a holding air cell (first air cell) 141 serving as a thigh holder 121, a treatment air cell (second air cell) 142 serving as a front treatment device 122 disposed forwardly thereof, and a treatment air cell (second air cell) 143 serving as a rear treatment device 123 and disposed backwardly of the thigh holder 121 and further including an external cover 120a for accommodating these air cells 141 to 143.

As shown in FIG. 20, the holding air cell 141 serving as the thigh holder 121 has a base end portion 141a that is not expanded at the time of air supply and an expansion portion 141b that is expanded at the time of air supply (see FIG. 19), thereby being designed so as to be expanded into a nearly fan-like shape when air is supplied and contracted into a flat shape when air is exhausted. Furthermore, with the expansion portion 141b positioned above the base end portion 141a, the almost entire portion of the holding air cell 141 is disposed so as to protrude upward from the seating face section 102d (the upper face of the cushion section 102c) of the seat section 102.

Hence, as also shown in FIG. 21A, when air is supplied to the holding air cell 141, the expansion portion 141b, the upper portion thereof, is expanded toward the center of the chair-type massage machine 101 in the left-right direction thereof so as to come close to the seating face section 102d. As a result, when air is supplied to the holding air cell 141 while the user sits on the seat section 102, the air cell can press the central area of each thigh in the longitudinal direction thereof from slightly above and can hold the thigh.

As shown in FIG. 20 and as in the case of the holding air cell 141, the treatment air cell 142 serving as the front treatment device 122 has a base end portion 142a that is not expanded at the time of air supply and an expansion portion 142b that is expanded at the time of air supply (also see FIG. 19), thereby being designed so as to be expanded into a nearly fan-like shape when air is supplied and contracted into a flat shape when air is exhausted. Furthermore, while the base end portion 142a is disposed so as to come closer to the holding air cell 141 than the expansion portion 142b, and the expansion portion 142b is positioned forwardly of the base end portion 142a, whereby the almost entire portion of the treatment air cell 142 is disposed so as to protrude upward from the seating face section 102d.

Hence, as also shown in FIG. 21B, when air is supplied to the treatment air cell 142, the expansion portion 142b on the front side is expanded toward the center of the chair-type massage machine 101 in the left-right direction thereof so as to move backward. As a result, when air is supplied to the treatment air cell 142 while the user sits on the seat section 102, the air cell can press the front side portion (around the knee) of each thigh in the longitudinal direction thereof slightly backward from the side.

As shown in FIG. 20 and as treatment air cell 142, the treatment air cell 143 serving as the rear treatment device 123 has a base end portion 143a that is not expanded at the time of air supply and an expansion portion 143b that is expanded at the time of air supply (also see FIG. 19), thereby being designed so as to be expanded into a nearly fan-like shape when air is supplied and contracted into a flat shape when air is exhausted. Furthermore, the base end portion 143a is disposed so as to come closer to the holding air cell 141 than the expansion portion 143b, and the expansion portion 143b is positioned backwardly of the base portion 143a, whereby the almost entire portion of the treatment air cell 143 is disposed so as to protrude upward from the seating face section 102d.

Hence, as also shown in FIG. 21B, when air is supplied to the treatment air cell 143, the expansion portion 143b on the rear side is expanded toward the center of the chair-type massage machine 101 in the left-right direction thereof so as to move forward. As a result, when air is supplied to the treatment air cell 143 while the user sits on the seat section 102, the air cell can press the rear side portion (around the buttocks) of each thigh in the longitudinal direction thereof slightly forward from the side.

In addition, as shown in FIG. 20, the holding air cell 141 and the treatment air cells 142 and 143 disposed in front thereof and at the back thereof are different in height dimensions, and the holding air cell 141 disposed at the center is configured so as to protrude upward higher than the treatment air cells 142 and 143 disposed in front thereof and at the back thereof. Hence, when expanded, the air cell 142 can hold each thigh more securely. Although the holding air cell 141 is configured appropriately so as to press the thigh from the outside and from above to hold the thigh as described above, the air cell can perform pressure treatment for the thigh by using the pressure force thereof as a matter of course.

Furthermore, the external cover 120a is configured so that the height of the central portion thereof is larger than those of the front and rear portions thereof to accommodate the air cells 141 to 143, and also configured so as to have a sufficient accommodation volume so that the air cells 141 to 143 are not hindered from being expanded when air is supplied thereto.

Moreover, as shown in FIG. 18, in the chair-type massage machine 101, sitting treatment devices 124 and 125 are disposed in the front portion and the rear portion of the seat section 102, respectively. These sitting treatment devices 124 and 125 have treatment air cells 144 and 145, respectively, and both of these treatment air cells 144 and 145 are configured so as to be expanded entirely from a flat state by supplying air. Hence, the treatment air cell 144 is expanded upward by supplying air to the treatment air cell 144 disposed on the front side when the user sits on the seat section 102, thereby being capable of pressure-treating the front side portions of the thighs upward from below. Still further, when air is supplied to the treatment air cell 145 disposed on the rear side, the treatment air cell 145 is also expanded upward, thereby being capable of pressure-treating the rear side portions of the thighs upward from below.

In addition, at the lower portion of the backrest section 103 of the chair-type massage machine 101 and at positions slightly above the seating face section 102d, lumbar treatment devices 126 and 127 are disposed in the left-right direction, and these lumbar treatment devices 126 and 127 have treatment air cells 146 and 147, respectively. The treatment air cells 146 and 147 have a configuration similar to that of the above-mentioned treatment air cell 142 (143); hence they have base end portions 146a and 147a that are not expanded at the time air supply and expansion portions 146b and 147b that axe expanded at the time air supply, thereby being designed so as to be expanded into a nearly fan-like shape when air is supplied and contracted into a flat shape when air is exhausted. Furthermore, as shown in FIG. 18, in the left and right treatment air cells 146 and 147, the base end portions 146a and 147a are disposed close to each other, and the expansion portions 146b and 147b are disposed so as to be positioned on the outsides of the base end portions 146a and 147a, respectively.

Hence, as shown in FIG. 21B, when air is supplied to the treatment air cells 146 and 147, the expansion portions 146b and 147b positioned outside in the left-right direction are expanded forward and to the central side in the left-right direction. As a result, by supplying air to the treatment air cells 146 and 147 when the user sits on the seat section 102 and the upper body is supported on the backrest section 103, the air cells can press both sides of the lumbar of the user from behind and outside.

[Functions of Chair-Type Massage Machine]

FIG. 22 is a block diagram illustrating the mechanical functions of the chair-type massage machine 101 described above. As shown in FIG. 22, the chair-type massage machine 101 includes a control section 200, and this control section 200 is installed below the seat section 102, for example, and is connected to a remote controller 201 (also see FIG. 17) that can be operated by the user.

Furthermore, the control section 200 is connected between drive sections 210 and 211; a direct-acting actuator 103b (also see FIG. 17) is connected to the drive section 210, and an air supplying/exhausting apparatus 220 is connected to the drive section 211. The drive section 210 outputs a drive signal according to an instruction from the control section 200, and the direct-acting actuator 103b is extended/contracted according to this drive signal. Hence, when an instruction is output from the control section 200 to the drive sections 210 by the operation of the remote controller 201 by the user or by the judgment of the control section 200, the direct-acting actuator 103b is extended/contracted, and the backrest section 103 is raised/lowered in the front-rear direction.

In a similar way, the drive section 211 outputs a drive signal according to an instruction from the control section 200, and this drive signal drives the air supplying/exhausting apparatus 220. The air supplying/exhausting apparatus 220 is formed of a pump, valves, etc. and connected to the above-mentioned air cells 130a to 130c and air cells 141 to 147 via flexible tubes so that air supplying/exhausting can be performed for these independently of one another. Hence, when an instruction is output from the control section 200 to the drive sections 210 by the operation of the remote controller 201 by the user or by the judgment of the control section 200, the air cells 130a to 130c and the air cells 141 to 147 are expanded and contracted independently by air supplying/exhausting of the air supplying/exhausting apparatus 220. As shown in FIG. 22, valves 141d to 147d corresponding to the air cells 141 to 147 are provided individually in the air supplying/exhausting apparatus 220 to expand and contract the air cells 141 to 147 independently.

Furthermore, the holding air cell 141 and the treatment air cells 142 and 143 are provided in both the left and right thigh treatment sections 120; in the chair-type massage machine 101 according to this embodiment, the air cells 141 to 143 on the left and right sides are designed so that they can be expanded/contracted independently of one another. However, when the air cells 141 to 143 on the left and right sides are not required to be expanded/contracted simultaneously, it may be configured so that the air cells on the left and right sides are expanded/contracted simultaneously by providing commonality in tubes through which air is supplied/exhausted to/from the air cells 141 to 143 on the left and right sides.

[Treatment Operations]

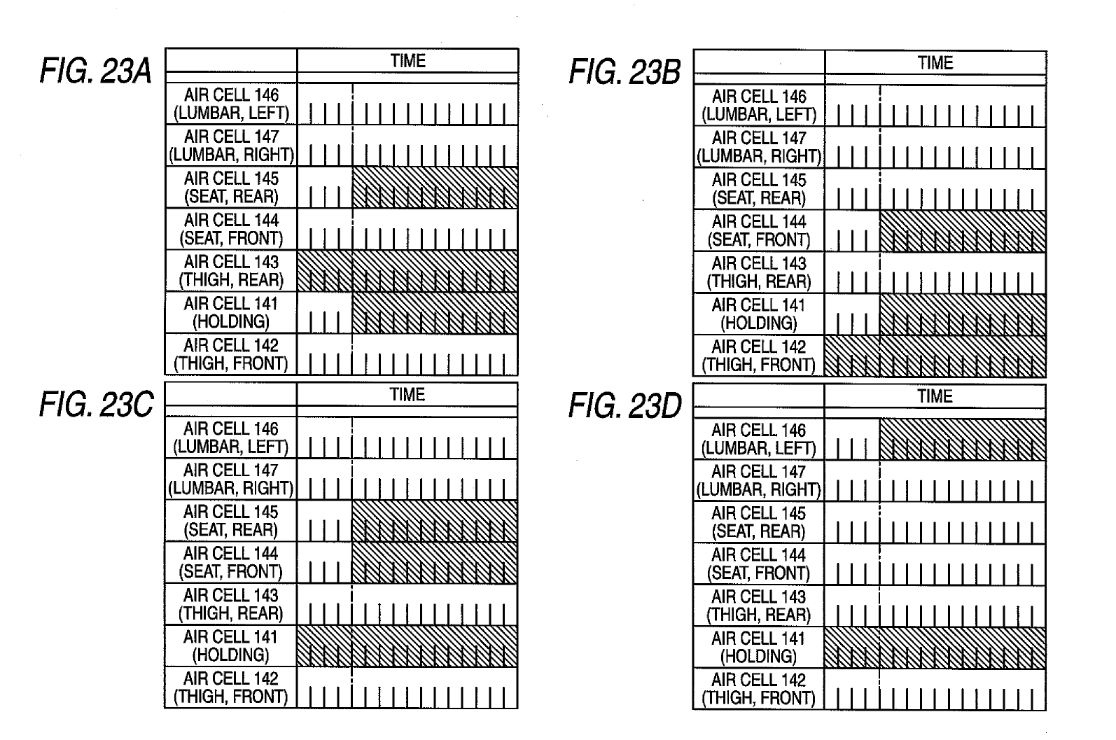

FIGS. 23A to 25B are timing charts for illustrating treatment operations performed for the user by the chair-type massage machine 101, in particular, treatment operations performed for the user using the air cells 141 to 147 described using FIGS. 18 to 22; the horizontal axis thereof represents an elapsed time, and the shaded portions thereof represent air supplying operations performed for the corresponding air cells. The timing charts shown in FIGS. 23A to 25B exemplify some of the treatment operations that can be performed by the chair-type massage machine 101; it is possible to set the air supplying/exhausting timings and expansion duration times for the respective air cells 141 to 147, the combinations of plural charts (including the combinations of respective parts) and repetitions (including the combinations of respective parts) by appropriate programming.

In the operation shown in FIG. 23A, after air is supplied to the treatment air cells 143 opposed to the rear outside faces of the thighs to expand the air cells at the beginning, air is supplied simultaneously to the holding air cells 141 and the treatment air cell 145 provided in the seat section 102 so as to be opposed to the buttocks from below to expand these air cells. By the such air supplying operations to the air cells 141, 143 and 145, the back portions and the outside portions of the buttocks and the thighs can be pressure-treated. Furthermore, after the holding air cells 141 are expanded, while the thighs are held by this expansion, the buttocks and the thighs are pressure-treated from below and from the outside using the treatment air cells 143 and 145, whereby treatment can be performed properly while the thighs are suppressed from being displaced.

In the operation shown in FIG. 23B, after air is supplied to the treatment air cells 142 opposed to the front outside faces of the thighs to expand the air cells at the beginning, air is supplied simultaneously to the holding air cells 141 and the treatment air cell 144 provided in the seat section 102 so as to be opposed to the front portions of the thighs from below to expand these air cells. By the such air supplying operations to the air cells 141, 142 and 144, the back portions and the outside portions of the thighs can be pressure-treated. Furthermore, after the holding air cells 141 are expanded, while the thighs are held by this expansion, the thighs are pressure-treated from below and from the outside using the treatment air cells 141 and 144, whereby treatment can be performed while the thighs are suppressed from being displaced.

In the operation shown in FIG. 23C, after air is supplied to the holding air cells 141 to expand the air cells at the beginning, air is supplied simultaneously to the treatment air cells 144 and 145 provided in the seat section 102 so as to be opposed to the front portions of the thighs and the buttocks from below to expand these air cells. By the such air supplying operations to the air cells 141, 144 and 145, the front side portions of the thighs and the buttocks can be pressure-treated. Furthermore, since after the holding air cells 141 are expanded, the treatment air cells 144 and 145 are expanded, it is possible to properly pressure-treat the front side portions of the thighs and the buttocks upward from below while the thighs are suppressed from being displaced from the beginning.

In the operation shown in FIG. 23D, after air is supplied to the holding air cells 141 to expand the air cells at the beginning, air is supplied to the treatment air cell 146 provided in the backrest section 103 so as to be opposed to the left side portion of the lumbar to expand the air cell. By the such air supplying operations to the air cells 141 and 146, while the left and right thighs are held and suppressed from being displaced, the left side portion of the lumbar is pressed forward and rightward, whereby twisting massage for turning the upper body clockwise can be performed.

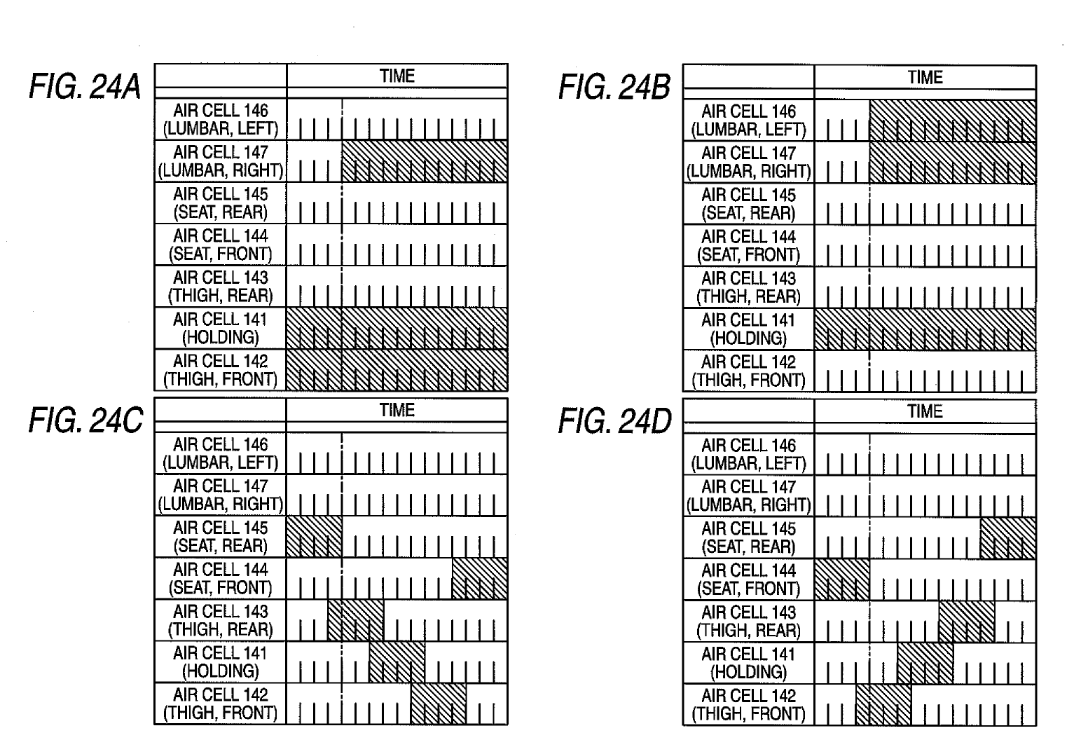

In the operation shown in FIG. 24A, after air is supplied to the holding air cells 141 and the treatment air cells 142 opposed to the front outside faces of the thighs to expand the air cells at the beginning, air is supplied to the treatment air cell 147 provided in the backrest section 103 so as to be opposed to the right side portion of the lumbar to expand the air cell. By the such air supplying operations to the air cells 141, 142 and 147, while the thighs are held and suppressed from being displaced, the front portions of the thighs are pressed from outside, whereby twisting massage for turning the upper body counterclockwise can be performed.

Air supplying to the treatment air cells 142 is not always necessary in this twisting massage; however, since the left and right treatment air cells 147 can be expanded/contracted independently in the chair-type massage machine 101 according to this embodiment, the upper body can be turned counterclockwise while the lower body is turned clockwise by expanding only the left one of the left and right treatment air cells 142 simultaneously with the expansion of the treatment air cell 147 for the right side of the lumbar, whereby further improvement in the effect of twisting can be expected. This can also be said for the twisting massage described in FIG. 23D.

In the operation shown in FIG. 24B, after air is supplied to the holding air cells 141 to expand the air cells at the beginning, air is supplied to the treatment air cells 146 and 147 provided in the backrest section 103 so as to be opposed to the left side portion and the right side portion of the lumbar, respectively, to expand the air cells. By the such air supplying operations to the air cells 141, 146 and 147, while the thighs are held and suppressed from being displaced, the lumbar can be pressed from behind and from the left and right outsides so as to be treated.

In the operation shown in FIG. 24C, air supplying is performed to the treatment air cell 145 provided in the rear portion of the seat section 102, to the treatment air cells 143 provided so as to be opposed to the rear side faces of the thighs, to the holding air cells 141 disposed forwardly of thereof, to the treatment air cells 142 disposed further forwardly thereof, and to the treatment air cell 144 disposed so as to be opposed to the front lower faces of the thighs in this order for a predetermined time to expand these air cells. In addition, when supplying air to the respective air cells 141 to 145, for example, before air supplying to the treatment air cell 145 being performed continuously for the predetermined time is completed, the next air supplying to the treatment air cells 143 is started so that air supplying operations to the two types of the air cells, which are performed consecutively in the order of air supplying, are overlapped temporarily. By virtue of the air supplying operations to the air cells 141 to 145 as described above, it is possible to attain a treatment of the so-called centrifugal method in which a treatment site on the body of the user is moved from a site close to the heart to a site away therefrom; in addition, by virtue of the overlapping of the air supplying operations, a treatment site can be moved not intermittently but smoothly.

In the operation shown in FIG. 24D, air supplying is performed to the treatment air cell 144 disposed so as to be opposed to the front lower faces of the thighs, to the treatment air cells 142 provided so as to be opposed to the front side faces of the thighs, to the holding air cells 141 disposed backwardly thereof, the treatment air cells 143 provided further backwardly thereof, and to the treatment air cell 145 provided in the rear portion of the seat section 102 in this order for a predetermined time to expand these air cells. Also in this case, air supplying operations to two types of air cells, which are performed consecutively in the order of air supplying, are overlapped temporarily. By virtue of the air supplying operations to the air cells 141 to 145 as described above, it is possible to attain a treatment of the so-called centripetal method in which a treatment site on the body of the user is moved from a site away from the heart to a site close thereto; in addition, by virtue of the overlapping of the air supplying operations, a treatment site can be moved not intermittently but smoothly. During the such operations (and during operations other than the such operations as a matter of course), the holding air cells 141 act as treatment air cells and can pressure-treat target sites. Furthermore, in the operations shown in FIGS. 24C and 24D, it may be possible to perform control so that the expanded states of the holding air cells 141 are maintained continuously during the period of the series of operations in which the other air cells 141, 142, 144 and 145 are expanded/contracted.

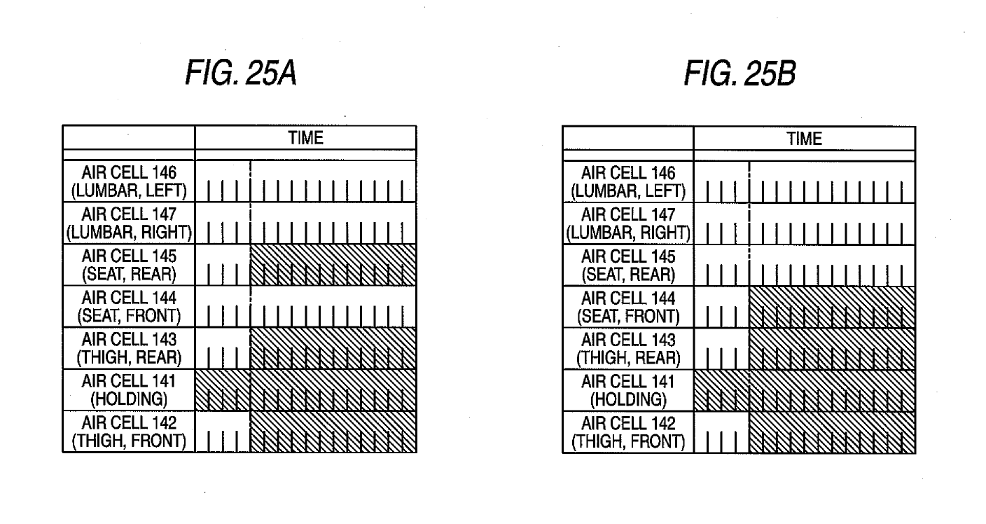

In the operation shown in FIG. 25A, after air is supplied to the holding air cells 141 to expand the air cells at the beginning, air is supplied simultaneously to the treatment air cells 142 and 43 provided so as to be opposed to the front and rear side faces of the thighs and the treatment air cell 145 provided in the seat section 102 so as to be opposed the buttocks to expand these air cells. By the such air supplying operations to the air cells 141 to 143 and 145, pressure treatment for the side portions of the thighs from the outside and pressure treatment for the buttocks from below can be performed simultaneously while the thighs are held and suppressed from being displaced.

In the operation shown in FIG. 25B, after air is supplied to the holding air cells 141 to expand the air cells at the beginning, air is supplied simultaneously to the treatment air cells 142 and 43 provided so as to be opposed to the front and rear side faces of the thighs and the treatment air cell 144 provided in the seat section 102 so as to be opposed the back faces of the front portions of the thighs to expand these air cells. By the such air supplying operations to the air cells 141 to 144, pressure treatment for the side portions of the thighs from the outside and pressure treatment for the back faces of the front portions of the thighs can be performed simultaneously while the thighs are held and suppressed from being displaced.

In the chair-type massage machine 101 according to this embodiment, in addition to the above-mentioned air cells 141 to 147, the air cells 130a to 130c are disposed in the armrests 104 and the footrest 5 as already described, and the mechanical massaging mechanism 107 is disposed in the backrest section 103. Hence, more various massage operations can be performed for the user by performing the operations of the air cells 130a to 130c and the massaging mechanism 107 in conjunction with the operations of the air cells 141 to 147. In particular, by performing treatment so that while the thighs are held using the holding air cells 141, the other portions are treated using the air cells 130a to 130c and 142 to 147 and the massaging mechanism 107, whereby appropriate treatment positions can be treated by applying appropriate pressure forces while the body is suppressed from being displaced.

### INDUSTRIAL APPLICABILITY

The present invention can be applied to a chair-type massage machine from which the user can obtain a sufficient stretching feeling. Furthermore, the present invention can be applied to a chair-type massage machine capable of pressure-treating the thighs while the thighs of the user sitting on the seat section are held properly.

1. A chair-type massage machine comprising:
a seat section on which the user sits,
a backrest section that supports the upper body of the user sitting on the seat section from behind,
an actuator that raises/lowers the backrest section,
a pressing section that is disposed inside the backrest section and that presses the upper body of the user from behind, and
a control section that controls operations of the actuator and the treatment section,
wherein the control section is configured so that the pressing section presses and pushes up around the lumbar of the user supported on the backrest section in conjunction with a backward tilting of the backrest section performed using the actuator.

2. The chair-type massage machine of claim 1,
wherein the control section is configured so that the pressing section presses and pushes up around the lumbar of the user after the backward tilting of the backrest section using the actuator is completed.

3. The chair-type massage machine of claim 2, further comprising:
a footrest that is provided forwardly of the seat section and that supports the legs of the user sitting on the seat section,
wherein the footrest is provided with holding sections that hold a given site falling within a range from the ankles to the toes of the legs of the user, and
wherein the control section is configured so that the holding sections hold the given sites of the user when the pressing section presses around the lumbar.

4. The chair-type massage machine of claim 1,
wherein the footrest is configured so that a lower portion thereof is movable up/down by rocking with respect to an upper portion thereof as an axis, and
wherein the control section is configured so that the footrest is moved down in conjunction with the backward tilting of the backrest section so as to obtain a state where the legs of the user are bent at the knees.

5. The chair-type massage machine of claim 1,
wherein the pressing section has:
a left side pressing section disposed relatively on a left side; and
a right side pressing section disposed relatively on a right side, and
wherein the control section is configured so that either the left side pressing section or the right side pressing section pushes up around the lumbar of the user from either left or right in conjunction with the backward tilting of the backrest section.

6. The chair-type massage machine of claim 1, further comprising:
a holding section that holds the upper body of the user supported on the backrest section,
wherein the control section is configured so that the holding unit holds the upper body of the user in conjunction with the backward tilting of the backrest section.

7. The chair-type massage machine of claim 1, further comprising:
a seat rocking section that is provided in the seat section and that rocks the buttocks of the user sitting thereon,
wherein the control section is configured so that the seat rocking section starts rocking the buttocks before the pressing section presses around the lumbar.

8. The chair-type massage machine of claim 1, further comprising:
a treatment section that performs a pressure massage for the user,
wherein the control section is configured so that the pressing section presses and pushes up around the lumbar after the pressure massage for the user using the treatment section is performed.

9. A chair-type massage machine comprising:
a seat section on which the user sits;
a backrest section that supports the upper body of the user sitting on the seat section from behind; and
thigh treatment sections that are provided so as to be opposed to the outside faces of the thighs of the user sitting on the seat section,
wherein the thigh treatment sections comprise:
thigh holders that hold the thighs of the user;
front side treatment devices that are disposed forwardly of the thigh holders and that pressure-treat the thighs; and
rear side treatment devices that are disposed backwardly of the thigh holders and that pressure-treat the thighs.

10. The chair-type massage machine of claim 9,
wherein the thigh holder has:
a first air cell that is expanded and contracted when air is supplied/exhausted and that is formed to be a flat shape in a contracted state,
wherein the first air cell is provided to protrude upward from a seat face of the seat section making contact with the user, and
wherein the first air cell is configured so that an upper portion thereof is expanded when air is supplied thereto while a lower portion thereof is used as a base end.

11. The chair-type massage machine of claim 10,
wherein at least one of the front side treatment device and the rear side treatment device has:
a second air cell that is expanded and contracted when air is supplied/exhausted and that is formed to be a flat shape in a contracted state,
wherein the second air cell is provided to protrude upward from the seat face, and
wherein the second air cell is configured so that, while an end portion of a side being close to the thigh holder is used as a base end, an end portion of a side being far away from the thigh holder is expanded when air is supplied.

12. The chair-type massage machine of claim 11,
wherein the first air cell of the thigh holder is configured so that an upward protrusion dimension from the seat section is larger than that of the second air cell of the front side treatment device or the rear side treatment device.

13. The chair-type massage machine of claim 9, further comprising:
a control section that controls operations of the thigh holders, the front side treatment devices and the rear side treatment devices,
wherein the control section is configured so as to be able to control the thigh holders, the front side treatment devices and the rear side treatment devices independently of one another.

14. The chair-type massage machine of claim 13,
wherein the control section is configured to operate at least one of the front side treatment device and the rear side treatment device to pressure-treat each thigh while the thighs of the user sitting on the seat section are held using the thigh holder.

15. The chair-type massage machine of claim 13,
wherein the seat section is provided with seat section treatment devices that upwardly pressure-treat the lower faces of the thighs or buttocks of the user sitting thereon upward, and
wherein the control section is configured to operate the seat section treatment devices while the thighs of the user are held using the thigh holders.

16. The chair-type massage machine of claim 13,
wherein the backrest section is provided with back section treatment devices that forwardly pressure-treat the lumbar or the back of the user whose upper body is held thereon, and
wherein the control section is configured to operate the back section treatment devices while the thighs of the user are held using the thigh holders.
